(19) United States
(12) Patent Application Publication
(10) Pub. No.: US 2005/0060535 A1
(43) Pub. Date: Mar. 17, 2005

(54) Methods and apparatus for monitoring local network traffic on local network segments and resolving detected security and network management problems occurring on those segments

(76) Inventor: John Alexander Bartas, Cupertino, CA (US)

Correspondence Address: CENTRAL COAST PATENT AGENCY, PO BOX 187, AROMAS, CA, 95004, US

(21) Appl. No.: 10/665,860

(22) Filed: Sep. 17, 2003

(51) Int. Cl. H04L 9/00

(52) U.S. Cl. 713/154

(57) ABSTRACT

A system for providing network security through manipulating data connections and connection attempts over a data-packet-network between at least two network nodes is provided. The system includes a system host machine, a first software application residing on the host machine for detecting and monitoring connection activity, a data store for storing connection related data, and a second software application for emulating one or more end nodes of the connections or connection attempts. In a preferred embodiment the system uses the detection software to detect one or more pre-defined states associated with a particular connection or connection attempt including states associated with data content transferred there over and performs at least one packet generation and insertion action triggered by the detected state or states, the packet or packets emulating one or more end nodes of the connection or connection attempt to cause preemption or resolution of the detected state or states.

### FIELD OF THE INVENTION

The present invention is in the field of hardware/software security for managed data networks and pertains particularly to a method and apparatus for solving detected security problems and other network management problems on a local data-packet-network (DPN) segment.

### BACKGROUND OF THE INVENTION

Along with recent expansion of the Internet network and connected sub-networks, network management problems and network and node security breaches have become rampant to an extent as to threaten usefulness of the vast information network. Hackers use sophisticated techniques to intercept files, steal files from breached computer nodes, and generally disrupt Web sites with vandalism. Virus authors write and execute malicious codes that continue to plague and disrupt node function. Web solicitors and advertisers inundate e-mail servers with vast amounts of junk mail including pornography advertisements, questionable business opportunities, and so on. Users of spy ware applications target individuals and invade computer privacy.

In addition to more serious security breaches and unwanted advertisement, there are many common network problems that arise from poor equipment, lines, miss-managed network routing, and so on. These are data traffic flow issues that occur during certain periods of use and can include network bottlenecks and the like.

Software and some hardware providers have developed a host of software solutions to deal with the types of problems mentioned above. For example, virus software solutions, privacy protection patches, browser speed-boosting applications, junk mail filters, cyber-sitting applications, software and hardware firewall installations and a host of other like products are available to consumers.

One problem with the current state of art of solutions made available to consumers to solve the problems listed above is that as independent solutions they address, by themselves, only a very small portion of the common problems occurring on the network and in association with network navigation and use. Collectively, the minimum installment of required solutions to take care of all or at least most of the above-stated problems is difficult to manage from a physical standpoint, for example, multiple software installations and configurations; insurance of compatibility between installed applications; and user effort required to understand the purposes and operations of the installed solutions can be daunting.

Further to the above, business users have a much higher stake in investment protection when it comes to problem free network navigation (for clients and operatives) and good security measures against compromise of data. Solutions for business users are generally provided in the form of packages that are simply more robust than would be the case with typical home users or consumers. In other words the solutions are the same just scaled up to perform on a business network level including server-based applications, security network implementations and the like. The same disparity exists for businesses as does for consumers as to incompatibility of side-by-side solutions on a same network or node, exhaustive installation and configuration tasks for pluralities of business nodes, and additionally, operating costs to practice such larger scale solutions lending to required monitoring, administration, and maintenance.

It has occurred to the inventor that in network security and performance management a more global outlook should be practiced instead of the “point of access approach” as is the current norm. Therefore, what is clearly needed in the art is a system accessible through a subscriber-based service for solving at least most if not all typically recurring local network security and management problems using a single hardware/software or software-only system that is updated and serviced by a third-party enterprise familiar with its operation. A system such as this could streamline the current complexities existing on many network segments including on network nodes resulting from multiple solution installations and additional protocols that must be implemented and managed.

### SUMMARY OF THE INVENTION

A system is for providing network security by managing and manipulating formed data connections and connection attempts initiated over a data-packet-network between at least two nodes connected to the network. The system includes a system host machine connected to the network; a first software application residing on the host machine for detecting and monitoring the connections and connection attempts; a data store for storing data about the connections and connection attempts; and a second software application for emulating one or more end nodes of the connections or connection attempts. The system using the detection software detects one or more pre-defined states associated with a particular formed connection or connection attempt in progress including those associated with any data content or type transferred there over and performs at least one packet generation and insertion action triggered by the detected state or states, the packet or packets emulating one or more end nodes of the connection or connection attempt to cause preemption or resolution of the detected state or states.

In a preferred embodiment the data-packet-network encompasses a Local Area Network connected to the Internet network enhanced with Transfer Control Protocol over Internet Protocol and User Datagram Protocol over Internet Protocol. The machine host of the system is one of a desktop computer, a router, an embedded system, a laptop computer, or a server. In one embodiment the system host is an especially dedicated piece of hardware.

I preferred application emulation of the end nodes of the connections or connection attempts is performed by generation and insertion into a data stream of the connection or connection attempt data packets using Transfer Control Protocol over Internet Protocol, the packets emulating packets from the current sending node in the connection. In this embodiment the packets inserted into a connection or connection attempt are one or a combination of Transfer Control Protocol reset packets or Transfer Control Protocol FIN packets. The nodes participating in the connections or connection attempts are desktop computers, servers, embedded systems, laptop computers or a combination thereof.

In a preferred aspect of the system the data-packet-network is an Ethernet network connected to the Internet network and the first software application is an Ethernet driver set to operate in promiscuous mode. Also in a preferred aspect the data about the connections or connection attempts includes one, more, or a combination of sender and receiver Internet Protocol addresses; Universal Resource Locators; source and destination ports; Transfer Control Protocol packet sequence numbers; Ethernet machine addresses; domain names; and packet header details. In one embodiment the data store comprises segregated datasets representing one or more of banned Internet Protocol addresses; banned domain names; banned Universal Resource Locators; banned network ports; and virus signatures. Also in one embodiment the data store further includes Ethernet machine addresses associated with bitmap icons representing individual machine types.

In a preferred aspect of the above-described datasets certain ones of the segregated datasets are built during runtime, maintained temporarily, and searchable by one of hash table indices or binary tree indices. In this aspect certain ones of the segregated datasets are uploaded into host Random Access Memory upon booting of the host system.

In a preferred embodiment the system also includes a third software application for detecting virus activity comprising: a software routine for hashing data passed over a formed data connection; and a software routine for comparing the hash data to a dataset containing virus signatures, the dataset searchable by hash table index, the hash entries therein derived individually from separate virus signatures. In this embodiment the hashing routine utilizes at least one sliding checksum window processing data and in the case of more than one, operating simultaneously on the data creating hash values to compare against hash entries in the hash index. In practice upon detecting a hit for a virus signature, the second software application interrupts data stream processing of one or more end points of the connection by sending a reset packet to stop download of the detected virus.

In another aspect of the present invention a software application is provided for manipulating one or more connection ends of a data network connection between two or more network nodes operating on a data-packet-network in response to detection of a pre-defined and undesirable state or states associated with the connection. The application includes a first portion thereof for detecting one or more states associated with the connection; a second portion thereof for generating packets emulating packet activity of the connection; and a third portion thereof for sending the emulated packet or packets to one or more parties of the connection. In preferred use the application uses a software communication stack to send one or more Transfer Control Protocol packets emulating in construction and sequence number a packet or packets sent by a sender end of the connection, the packet received by the receiver of the connection wherein the receiving end acknowledges the packet or packets as being a valid packet or packets received from the sender of the connection, the packet or packets sent causing pre-emption or resolution of the detected state or states.

In a preferred embodiment the data-packet-network comprises a local-area-network enhanced with Transfer Control Protocol over Internet Protocol and User-Datagram Protocol over Internet Protocol. In this embodiment the Local Area Network is an Ethernet network connected to an Internet network. Also in preferred embodiments manipulation of connection ends is performed by generation of and insertion of data packets to one or more nodes of the connection using Transfer Control Protocol over Internet Protocol, the generated packets emulating sender packets in construction and sequence number. In these preferred embodiments the packets inserted into a connection data stream are one or a combination of Transfer Control Protocol reset packets or Transfer Control Protocol FIN packets emulating at least one sending party of the connection.

In one aspect the software communication stack is an on-board Transfer Control Protocol over Internet Protocol communication stack. A pre-defined state includes one, more, or a combination of a banned Internet Protocol address; a banned Universal Resource Locator; a banned domain name; a detected virus signature; a banned port; and banned data content defined by filter. The connection end nodes are desktop computers, servers, embedded systems, laptop computers, or a combination thereof.

In a preferred use Transfer Control Protocol packets are generated and inserted according to pre-defined trigger events associated with existing states or knowledge of imminence thereof discovered during operation. Also in a preferred embodiment of the invention the application further includes a portion thereof integrated with the first portion for detecting virus activity comprising a routine for hashing data passed over a formed data connection; and a routine for comparing the hash data to a dataset containing virus signatures, the dataset searchable by hash table index, the hash entries derived individually from the virus signatures.

In one aspect of the invention the predefined state is banned content and resolution thereof includes inserting content including machine readable script by one or a sequence of TCP packets containing replacement content. In all preferred embodiments virus searching is supported by algorithm supporting generation and then comparison of created hash values derived from active connection data streams to hash table entries stored in a data store and to return a hit upon obtaining a match.

In one embodiment the third portion of the software is integrated with a messaging client for generating automated alerts to end nodes whose connections have been manipulated. Data hashing is performed in all embodiments using one or more sliding checksum windows for hashing data transferred over an active connection.

In one embodiment of the present invention each checksum window processes 9 bytes of data 3-bytes at a time, each three-byte section treated as a single 24-bit number. In all embodiments for virus checking the hash table is sparsely populated and wherein the index thereof is bit-masked to reduce the overall size of the table and increase performance of the search.

In still another aspect of the present invention a fast pattern search system is provided for detecting virus patterns over a data network comprising a promiscuous mode driver for intercepting data packets on the network; a hashing module for creating hash values from same-lengths of intercepted data; a data buffer section for storing hash values; and a processing component for comparing created hash values to an index of hash entries maintained in a data store. The hash entries in the data store point to virus patterns also stored in the data store and where upon a match between a created hash and a hash entry results in generation of one or more packets emulating at least one party node to the connection, the packet or packets sent to pre-empt the download of the particular virus found.

In a preferred embodiment of this system the network is a local area network enhanced with Transfer Control Protocol over Internet Protocol and User Datagram Protocol over Internet Protocol, the Local Area Network connected to the Internet network. Also in a preferred aspect the promiscuous mode driver is an Ethernet driver and the network protected is an Ethernet network or a segment thereof.

In one embodiment the length of data hashed by the system from a connection data stream for a single hash value is 9-bytes. I a preferred application of this embodiment the hashing module employs one or more sliding checksum windows and re-calculates new hash values based on data units entering or exiting the window and the 3-byte sections are treated as a single 24-bit number. In one aspect of the above-described embodiment the data buffer is RAM buffer.

In one embodiment of the system more than one packet is generated and sent upon a match, the packets comprising a TCP reset packet sent to the source node of the virus and a TCP FIN packet sent to the receiving node of the virus. In another embodiment more than one packet is generated and sent upon a match, the packets comprising a TCP reset packet sent to the source node of the virus and a TCP reset packet sent to the receiving node of the virus.

In one embodiment the system includes a routine for calling a messaging client to generate a message alert and then sending the alert to the receiving node of the virus, the alert informing of the activity and providing further instruction. In still another embodiment the system includes a routine for calling a machine-to-machine messaging protocol to send a machine-readable command to an application running on the receiving node of the virus, the application adapted to clean history files and any logical or physical links or references to the virus source.

In yet another aspect of the invention a method is provided for denying a connection to a data source on a data network, the connection initiated from a local network node comprising steps of (a) maintaining data identifying the banned data source; (b) detecting a SYN packet from the local node sent to the host node of the banned data source, the SYN packet identifying at least the banned data source; (c) generating a TCP reset packet emulating one sent from the local node and sending the packet to the host node of the banned data source terminating the handshake process for accessing the data source at the host node of the banned data source; and (d) generating a TCP reset packet emulating one sent from the host node of the banned data source and sending the packet to the local node terminating the handshake process for accessing the banned data source at the local node.

In a preferred aspect of the method in step (a) the banned data source is identified by one or a combination of IP address, Universal Resource Locator, port identification or any portion thereof Also in a preferred aspect in step (b) the local node is connected to an Ethernet network and the host node is maintained on the Internet network, the method of detection comprising promiscuous mode monitoring and comparison against stored data.

In still another aspect of the present invention a method for stopping a download of a pop-up advertisement over a data network from a data source to a local node on the network is provided. The method includes steps of (a) monitoring a browser session between the local node and the source node; (b) detecting execution by the local browser of an embedded code calling an advertisement to be served; (c) generating a TCP FIN packet emulating one sent from the data source node and sending the packet to the local node, the packet indicative that the source node has finished transmitting the ad data; and (d) generating a TCP reset packet emulating one sent from the local node to the TCP connection source of the ad data requesting a reset of the connection preventing the source node from serving the ad data.

In a preferred aspect of this method the local node is connected to an Ethernet network and the data source is maintained by a node on the Internet network, the method of detection comprising promiscuous mode monitoring and comparison against stored data. Also in a preferred aspect in step (c) the FIN packet includes a machine-readable code containing one or more instruction codes for the browser application. In one embodiment in step (c) the machine-readable code is JavaScript instructing the browser not to open a container window for the ad data and to close the container window if already called.

In yet anther aspect of the present invention a method is provided for configuring a resource on a local network for access from the network by a node using Domain Name Service protocol. The method includes steps of (a) pre-assigning a name to the shared resource; (b) storing the pre-assigned name in a data store; (c) publishing the pre-assigned name to local nodes on the network; (d) monitoring Domain Name Service requests from the local nodes; (e) detecting the pre-assigned name in a request; (f) generating a Domain Name Service reply emulating in construction and sequence number a reply sent from a Domain Name Server, the reply containing an IP address through which the resource may be accessed; and (g) sending the reply to the local node that initiated the request.

In a preferred embodiment of this method in step (a) the shared resource is one of a printer, a server node, or a network-based software application. In preferred application of the method in step (a) the pre-assigned name is not registered at a Domain Name Server. Also in preferred application in step (d) monitoring the network for Domain Name Service requests is performed in promiscuous mode using an Ethernet driver wherein the local network is an Ethernet network.

In one embodiment of the method in step (e) detection is accomplished by comparing all requests for Domain Name Services made from local nodes to the store containing the pre-assigned Domain Name. Now for the first time a single point solution is provided for handling a plurality of network security issues.

### BRIEF DESCRIPTION OF THE DRAWING FIGURES

FIG. 1 is a network overview of local network segments enhanced with network protection software according to various embodiments of the present invention.

FIG. 2A is a block diagram illustrating the main components of the SW of FIG. 1.

FIG. 2B is a block diagram illustrating a plurality of sub-components of the modules of the SW of FIG. 2A.

FIG. 3 is a network overview of a process for filtering and/or replacing content ordered from a Web server according to an alternate embodiment of the present invention.

FIG. 4 is a network overview of a process for cleaning e-mail ordered from an e-mail server according to an alternate embodiment of the present invention.

FIG. 5 is a network overview of a process for denying a network connection between a network client and a banned server according to an embodiment present invention.

FIG. 6 is a network overview of a process for monitoring a working connection and then eliminating TCP browser connections associated with unwanted Pop-up advertisements according to an embodiment of the present invention.

FIG. 7 is a network overview of a process for Providing Domain Name Service functionality in an automated fashion using pre-defined names according to an embodiment of the present invention.

FIG. 8 is a network overview of the process of FIG. 7 using a load server to balance traffic between multiple IP addresses according to an embodiment of the present invention.

FIG. 9 is a block diagram illustrating a virus detection process according to a preferred embodiment of the present invention.

FIG. 10 is a process flow chart illustrating steps for detecting an incoming virus and resolving the potential threat according to various embodiments of the present invention.

FIG. 11A is block diagram illustrating a hashing operation on a data stream according to a simplest embodiment.

FIG. 11B is a block diagram illustrating a hashing operation on a data stream according to a preferred embodiment.

FIG. 12 is a block diagram illustrating a hash table and signature database according to the hashing embodiment of FIG. 11B.

FIG. 13 is a network overview illustrating a process for replacing and/or filtering Web-content according to a preferred embodiment of the present invention.

FIG. 14 is a network overview illustrating a process for scanning and filtering e-mail according to a preferred embodiment of the present invention.

FIG. 15 is a process flow chart illustrating basic receiving logic for data packets.

FIG. 16 is a network overview illustrating protection against a denial of service (DOS) SYN attack according to an embodiment of the present invention.

FIG. 17 is a network overview of a method for slowing down a data send rate to conserve local network bandwidth according to an embodiment of the present invention.

### DESCRIPTION OF THE PREFERRED EMBODIMENTS

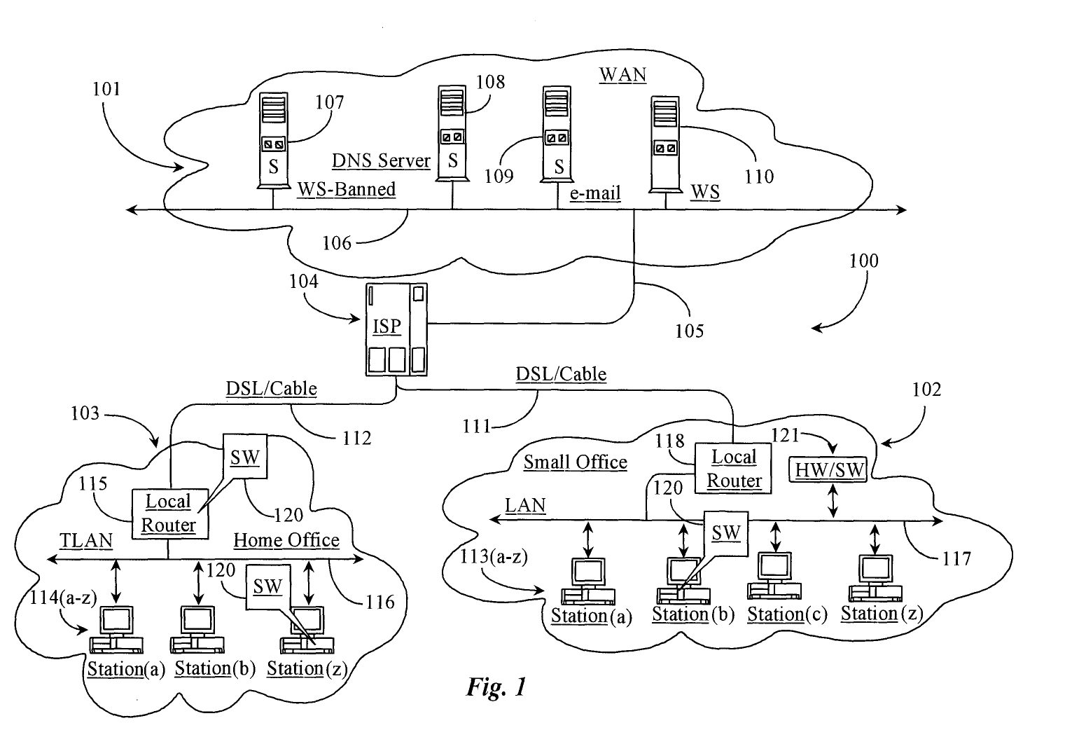

FIG. 1 is a network overview 100 of local network segments enhanced with network protection software according to various embodiments of the present invention. Overview 100 represents any communication and transaction network scenario wherein local network segments, illustrated herein as segments 102 and 103 have connection to a wide-area-network (WAN) illustrated herein as WAN 101.

WAN 101 is, in a preferred embodiment, the well-known Internet network. In other embodiments, WAN 101 could be an Intranet, or another type of private or corporate WAN. WAN 101 in all possible embodiments is adapted to support Transfer Control Protocol/Internet Protocol (TCP/IP), which is a well-known and widely practiced network communication protocol that occupies at least one layer of the familiar Open System Integration (OSI) model of network functional layers.

WAN 101 has a network backbone 106 illustrated as a double-arrowed line extending there through. Backbone 106 represents all of the lines, connection points, gateways, routers, and other equipment that make up, in this case, the Internet network as a whole. Therefore, there are no geographic limitations to the practice of the present invention.

WAN 101 has a plurality of server nodes illustrated herein as server node 107, server node 108, sever node 109, and sever node 110 connected to backbone 106 and adapted for communication as well as for serving electronic information typical of Internet-based information. Examples include network transacting using electronic forms, Hypertext Markup Language (HTML) pages that are viewable remotely using a browser application, Electronic Mail, machine-to-machine service information and so on.

Server node 107 is more specifically a Web server (WS) that serves some form of undesirable content like pornography or other questionable content and is therefore marked as a “banned server”. This means that it has a network address typically referred to herein as an Internet Protocol (IP) address that is known by some convention and is associated with the knowledge that the server contains the undesirable content.

Server node 108 is a Domain Name Server (DNS). DNS server 108 represents a local WS that provides IP address information to any node that requests such information by submitting a domain name such as. DNS server 108 maps the, domain name to an IP address for enabling a network connection between the requesting node and the server. Registered domain names are distributed over a plurality of DNS servers such that whenever a requesting node logs on and requests a domain name through typing the name into a browser field or by clicking on a link or bookmark, the server sends the correct IP address information in a reply to the requesting node, which can then begin forming a TCP/IP connection with the server for the purpose of network interaction.

Server 109 is an e-mail server adapted for the purpose of retaining and serving electronic mail to authorized recipients. A server such as server 109 would typically be hosted by a service providing electronic mail services. Electronic mail can include short test messages, messages with electronic media attached, voice messages known as voice mails, and so on. Typically a user operating a supported e-mail client application logs on to the network through an Internet Service Provider (ISP) illustrated in this example as ISP 104 and connects with server 109 to download and upload e-mail using a Post Office Protocol (POP) or a Simple Message Transport Protocol (SMTP). E-mail may also be provided in a Web-Hosted embodiment like Hotmail™ or another type of Web-mail server. In this case a particular e-mail client is not required; rather all of the mechanics are Web-hosted.

Server 110 is a standard Web server adapted to serve any type of electronic information to requesting clients. In this embodiment, server 110 is not illustrated as a banned server. Therefore, there are no conventions in this example listing the IP address of server 110 as banned. There will be many more available servers of many descriptions connected for communication to WAN 101. The inventor illustrates just four servers in this example and deems the number and variety sufficient for explanatory purpose.

ISP 104 is connected to WAN 101, more particularly to backbone 106 by way of a network cable 105. Cable 105 is typically a fiber optics high-speed carrier robust in bandwidth capability. Local networks 102 and 103 have connectivity to ISP 104, such connectivity adapted to provide network access to both networks. For example, network 102 has connection to ISP 104 by way of a high-speed Digital Subscriber Network (DSL) or cable line 111. Likewise, network 103 has connection to ISP 104 by way of a DSL or cable line 112.

DSL/cable lines 111 and 112 can, in some embodiments be other types of service lines without departing from the spirit and scope of the present invention. One example is an Integrated Services Digital Network (ISDN) carrier. In another embodiment networks 102 and 103 may be local wireless networks gaining access to WAN 101 through one or more gateways hosted by one or more wireless service providers (WSPs). One with skill in the art of network architecture will appreciate the often-blurred boundaries between lines or carriers involved in carrying data packets and those lines and carriers used for analog traffic. For example, access for each data network 102 and 103 may be forged through the well-known Public-Switched-Telephony-Network (PSTN) although none is specifically illustrated. It is also noted herein that Internet access for networks 102 and 103 may also be through simple dial-up modem service.

Network 102 is in a preferred example, a small office Local-Area-Network (LAN) adapted as an Ethernet network, a well-known standard. Typically 10-base T or similar rated cabling provides network connectivity between nodes within network 102. Connective cabling is illustrated herein as a LAN 117. It will be apparent to one with skill in the art that network 102 may be of another type of data-packet-network (DPN) other than an Ethernet network without departing from the spirit and scope of the invention. However an Ethernet network is preferred in this example because of built-in promiscuous mode functionality that is leveraged in practice of the present invention. LAN 117 is adapted for communication according to TCP/IP and other Internet protocols. Network 102 can be another type of local network other than Ethernet as long as an equivalent technology for monitoring data is provided in place of the Ethernet promiscuous mode (P-mode) functionality.

A packet routing node (router) 118 is provided within network 102 and adapted to route data packets. For example, all data packets incoming from WAN 101 to destination nodes on network 102 will move through router 118. Likewise, all outgoing data packets are routed through router 118. Similarly, internal communication local to network 102 passes through data router 118. Router 118 is typical equipment of Ethernet network set-ups. Router 118 has connection to LAN 117 by way of standard cabling, which in one embodiment is 10-base T cabling (most common).

LAN 117 has a plurality of computer nodes 113a-z connected thereto and adapted for communication on the network. Computer nodes 113a-z represent any type of computing device using the network including Laptop computers and embedded systems. It will be apparent to one with skill in the art that there may be many more than four computer nodes within network 102 without departing from the spirit and scope of present invention. The inventor illustrates four such computer nodes and deems the number illustrated sufficient for explanatory purposes. Computer nodes 113a-z may be referred to throughout this specification as workstations or desktops.

An instance of software (SW) 120 is illustrated in this example as running on and executable from computer node 113b. SW 120 is adapted to maintain security and network management within network 102. Computer node 113 is designated, in this example, as the desktop responsible for P-mode monitoring and network security because of the presence of software 120. No other desktop or connected machine in network 102 is required to have any instance of software installed as long as it is provided to one machine (desktop 113b).

Computer nodes a, c and z are monitored for activity by desktop 113b running software 120. Software 120, also termed “Buster” software by the inventor, performs a variety of network security functions including virus detection, Web content filtering, network connection management, and other like functions. In one embodiment of the present invention, instead of software 120 a hardware/software combination HW/SW 121 is provided as a standalone device connected to LAN 117. In this case the SW portion of device 121 is analogous to SW 120. Also in the case of hardware/software device 121, standard Ethernet functionality and TCP/IP capability is provided. One other computer on network 102 may be designated as a GUI interface for device 121 if device 121 has no independent monitor screen.

Network 103 is exemplary of a home office network. A local router 115 (analogous to router 118) is provided within network 103 and is adapted to route incoming and outgoing communication over a LAN 116. In a preferred environment of the present invention, the architecture of home office network 103 is typically analogous to the architecture of small office network 102. The only real difference between the two networks is that network 103 is a home office and network 102 is a small office. LAN 116 is adapted with TCP/IP and other Internet protocol as was described with reference to LAN 117 within network domain 102. However this should not be construed as a limitation of the present invention.

In one embodiment LAN 116 may comprise the internal plain-old-telephone-service (POTS) telephone wiring of a home. There are kits available as well that use the copper electrical wiring of a home using the outlet boxes as connectors. Such home network schemes are applicable to the present invention as long as a suitable monitoring mode such as P-mode monitoring is provided and enabled. For the purpose of example and to illustrate best use embodiments, an example of Ethernet will be described for networks 102 and 103 throughout the rest of this specification.

A plurality of computer nodes 114a-z is provided within network domain 103 and connected to LAN 116. One with skill and the art will appreciate that there may be more than three computer nodes 114 provided within network domain 103 without departing from the spirit and scope the present pension. The inventor illustrates three such computer nodes and deems illustration sufficient for explanatory purposes. Computer nodes 114a-z represent any computing device that uses the network, for example desktop computers running any of several known operating systems. In this example computer node 114z has an instance of software 120 provided thereon, which is analogous to software 120 running on computer node 113b within network 102. There are no appreciable differences between instances installed on different nodes accept perhaps capacity variations related to network size (number of machines) and available bandwidth for each separate network. Computer node 114z then is responsible, with the aid of SW 120 for protection of the other nodes on network 103.

In one embodiment of the present invention instead of SW 120 running on server z, an instance of software 120 is provided to execute on local router 115 instead. SW 120 regardless of host node type including the SW portion of device 121, also termed a “Buster Box” is adapted to perform all of the network security functions for all of the other nodes connected to their respective host networks. The illustration of a plurality of software instances is simply exemplary of optional host-nodes on which SW 120 of the present invention may be provided on and from which the software can be executed. It is noted herein that a difference in capacity, configuration, or number and exact types of functions provided by SW 120 depending on host node description, network description and, perhaps prevailing OS type might be evident and is a function of design consideration. For example, SW 120 may be provided of differing versions, one for Windows™, one for Macintosh™, and one for Linux operating systems.

With regard to Ethernet technology, which is a preferred use embodiment, all computer nodes connected to the local network, in this case nodes 114a-z (network 103) and nodes 113a-z (network 102) have an Ethernet network card (not illustrated) installed therein. It is also known that an Ethernet network may support what is known as a promiscuous mode (P-Mode) operation as previously described above. P-mode enables the particular host executing it to “see” all incoming and outgoing data packets as well as all machine-to-machine control messaging and any error messaging that occurs on the network. Typically, an Ethernet P-mode is used to monitor network traffic activity on any small to mid-sized local Ethernet network segment.

The Ethernet promiscuous mode driver is used in a preferred embodiment of the present invention to enable a designated machine (hosting SW 120 on a particular network to see all activity occurring on the network so that SW 120 has all of the information required in real time to perform the various functions it is adapted to perform. The SW of the present invention is a single point solution capable of enabling service denials, connection denials, breaking of existing connections, reforming broken connections, and acting as or inserting a proxy in a formed connection. These functions are under taken so that network security and integrity may be maintained in preferred embodiments.

SW instance 120 utilizes data repository and database features of a host desktop or in the case of a “Buster Box” built-in memory and storage capability. A SW Instance installed, for example on desktop 114z or on 113b utilizes hard disk space and temporary cache RAM of each node respectively. In the case of a DSL router installation (SW 120 on router 115), router 115 is equipped with sufficient memory for the required data storage.

In practice of the present invention SW 120 manages and controls various aspects of network communication undertaken by client nodes 114a-z and 113a-z. It is noted herein as well that in the case of desktop installation of SW 120 the host machine is also a client machine meaning that the SW also protects its host node on the network just as any other client node.

It is known in the art that a TCP/IP connection is formed between a requesting node and a server node through executing a series of request-response connection legs required to form a network connection under TCP. For example, a requesting node sends a request to “synchronize” (SYN packet) to a server node. The server node sends a synchronize acknowledgement (SYN/ACK packet) back to the requester. The requester then sends an acknowledgement (ACK packet) back to the server and the connection forms enabling bi-directional data transfer. This protocol is the hand shaking between machines on a network enabling an open data connection.

The software of the present invention utilizes the Ethernet promiscuous driver on a host machine connected to a local network segment to detect when any of the client nodes engage in communication with a remote node. SW 120 has a series of database tables (not shown) listing data for comparison against current activities on the local network. For example, domain names, universal resource locators (URLs), IP addresses, connection tuples, virus patterns, and certain ports are listed in these database tables, which in preferred applications are largely hash tables. The static tables maintained for domain names, IP addresses, URLs, and so on contain black-list data so that when a local network node attempts to connect to a specific port, URL, IP address, etc., SW 120 can deny the connection before it is formed using TCP packet insertion techniques, which will be described in more detail later in this specification.

Virus tables mentioned above are stored for comparison using a novel fast searching technique that uses created hash values for comparison against unique hash values that are tabled and point to specific virus patterns. Again, TCP packet insert technologies are used to break a connection if a virus is detected, and alert functions are activated to resolve the issue on the local node that formed the connection.

SW 120 can also, in some embodiments act as proxy machine representing a trusted source for the purpose of data filtering and content replacement. SW 120 has a single machine host on any typical local network and protects all of the connected local machines on the network. In some embodiments a network grows and becomes too large for a single SW instance to protect. In this case, several solutions are possible. Overloaded networks are commonly segmented or divided. When this is done, an additional instance or instances of SW 120 can be provided to protect each new network segment formed.

In one embodiment wherein a network is segmented, each new instance of SW 120 can be programmed to perform certain subsets of the tasks normally performed by a single instance. In this case each instance protects the plurality of the divided segments concerning its pre-programmed subset of tasks. In this way SW 120 can be distributed over a plurality of nodes in a task-specific manner.

In still another embodiment, if a network becomes too large for one instance to handle on a current machine, the particular instance can be un-installed and re-installed on a machine with a higher processor performance rating.

SW 120 does not directly utilize hard-disk resources of its host node during run-time. Rather, it reads the stored data from static memory to RAM at boot-up so that performance is much improved over typical virus applications and the like. AS SW 120 runs in the background on its host node, it builds additional information about connections formed by any nodes operating on the network keeping the connections data stored in RAM. A connection tuple contains the IP source and destination address as well as the source port and destination port identification. These connection tuples are formed on the fly and stored in RAM on a temporary basis and are purged after a certain period of time unless there arises a reason to retain one or more of the connection parameters for permanent listing. One reason would be that a specific connection has a destination address that turns out to be an address that should, because of detection of undesirable content, make the list of banned IP addresses. It may be that the specific address was not originally on the list of banned addresses.

At the end of a period of network activity or during sufficient idle time during activity, SW 120 performs one or more table updates of RAM data into permanent data storage to retain new data that should be tabled. For example, new virus patterns discovered are hashed upon discovery and the complete signatures are stored permanently when time allows.

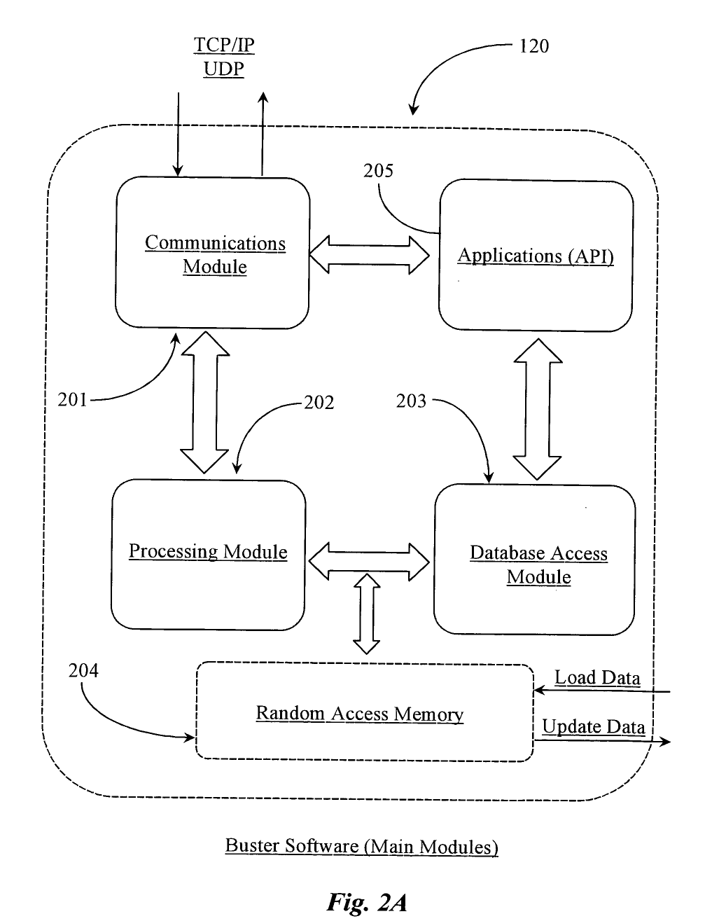

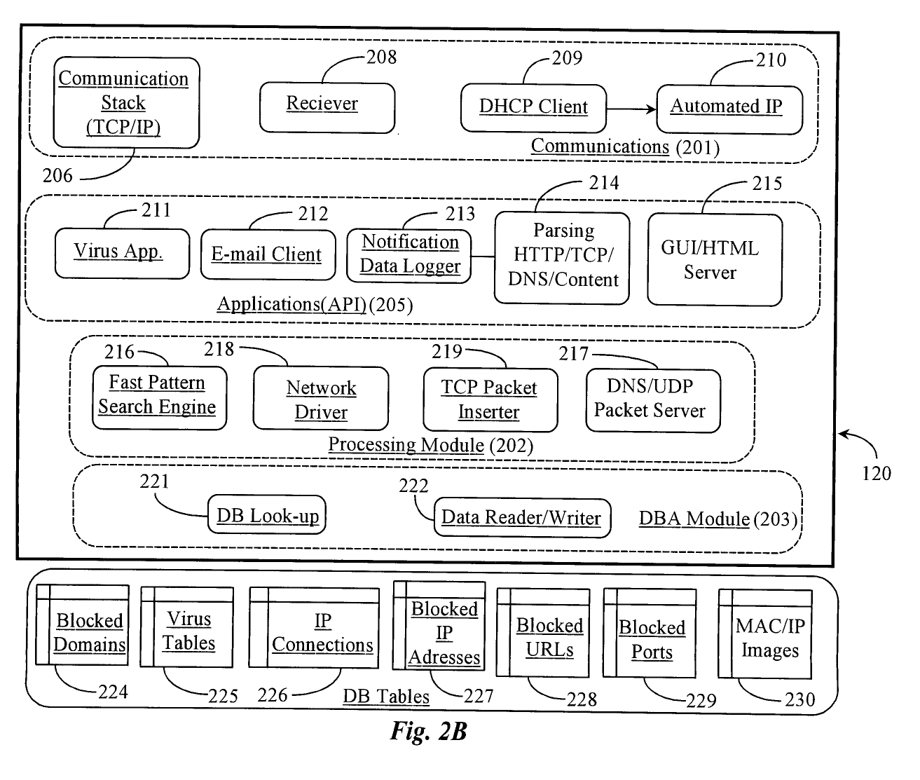

FIG. 2A is a block diagram illustrating the main components of SW 120 of FIG. 1. SW 120 has 4 main functional components. These are a communications module 201, a processing module 202, a database access module 203, and an applications (API) module 205.

Communications module 201 is provided within SW 120 and adapted for communication on the local network with other nodes connected to the network and for communicating with nodes that are external from the local network. Module 201 contains all of the sub-modules necessary for normal network communication such as a TCP/IP stack. Module 201 enables SW 120 to receive on-line updates and to send alert messages to other network nodes. Module 201 also enables SW 120 to reset network connections that are forming or to break connections that are already formed.

Processing module 202 is provided within SW 120 and is adapted to perform processing related to certain important tasks. For example, processing logic within module 202 enables SW 120 to process certain data packets, parse data and data attachments, and perform data table searches supported by a fast searching algorithm among other functions. A RAM memory block illustrated herein as random access memory 204 largely supports processing module 202. Processing module 202 may use static memory of its host machine for certain standard function, however for normal run-time processing, RAM block 204 is utilized. During configuration, a specific amount of RAM of the host machine is dedicated for processing by SW 120.

Database access module 203 is provided within SW 120 and adapted to provide access to RAM-based temporary tables and access to permanent data storage facilities on a host machine. All of the modules of SW 120 can gain access to data through module 203.

Application (API) module 205 is provided within SW 120 and is adapted for application program interface to any applications on a host machine that SW 120 may, from time to time interact with such as host-based Virus ware applications, e-mail applications, and any other applications that may integrate with or be leveraged by SW 120 in certain circumstances. Module 205 may also in some embodiments host resident applications, which are incorporated as on-board application of SW 120.

It is noted herein again with reference to RAM block 204 that all data required for run-time performance of SW 120 is loaded into RAM 204 at boot-up. The only requirement for SW 120 to access hard data storage on a host machine is when updates to the data are required.

FIG. 2B is a block diagram illustrating a plurality of sub-components of the modules of SW 120 of FIG. 2A. SW 120 is illustrated in this example with modules 201, 202, 203, and 205 further broken down into various sub-components. A standard TCP/IP communication stack 206 is provided within communications module 201 and is adapted to enable standard TCP/IP communication as is known in the art. In an alternated embodiment it is possible to leverage a host TCP/IP stack for communication but is a preferred embodiment this is not done. It is noted herein that SW 120 and communications module 201 is also capable of User Data gram Protocol (UDP) communication, which is another type of data transfer protocol used over IP. In a preferred embodiment TCP/IP is the preferred and most common protocol leveraged by SW 120.

A receiver module 208 is provided within communications module 208 and is adapted as a data packet receiver. Receiver module 208 receives or “sees” all packets occurring on the local network segment by acting as a hand-off point for P-mode. Module 208 contains logic that directs how packets are processed by what type of packets they are. IP packets, UDP packets, address resolution protocol (ARP) packets, and Netbeui packets comprise some of the packet types that are typically encountered. Logic within modules 208 directs what should be done with a particular data packet received. More detail about receiver logic of receiver 208 will be provided later in this specification.

Module 201 has a dynamic host configuration protocol (DHCP) client provided therein, which enables the host machine to function without a static IP address. A DHCP server (network server) adapted to assign temporary IP addresses from a particular range of addresses allotted for a given network responds to the DHCP client request for an IP address when the client boots up on the network. The server (usually an Internet server) also configures DNS and WINS services, and in some cases, other network services such as NTP on behalf of the requesting DHCP client. A reserve Auto IP assignment module 210 is also provided as an optional module that can reserve an IP address for the Host in the absence of DHCP functionality or in the event that DHCP undergoes a fault condition or is not configured properly.

Applications module 205 includes on-board applications and/or application program interfaces (APIs) to machine host applications. A virus scanning application 211 is provided within applications module 205 and is adapted as a configurable virus eradication component that is a part of a unique fast pattern search module, which will be described further below. Part of the unique function of SW 120 is constant virus protection for all nodes connected to the local network monitored by SW 120 through P-mode capability. Application 211 may be thought of the user interface portion of this functionality. Therefore application 211 is assumed to have an interface for configuration, an engine for obtaining virus updates from a network source, and an engine for resolving a situation of a virus detected on the host.

In one embodiment of the present invention instances of application 211 may be distributed to run on all of the other nodes connected to the local network and under the domain of SW 120. In this case such instances may replace traditional OS-based virus detection and eradication programs. In the event of a detected virus associated with a connected node that does not host SW 120, a command may be sent by the SW host machine to the affected machine that instructs its instance of virus application (211) what steps to take. In an alternate embodiment of the present invention, application 211 is optional and not necessarily provided. In this case connected nodes may retain their original scanning programs as a supplement to the universal network virus detection capability.

In a further enhancement to the above, SW 120 has an additional network-based API (not illustrated) to certain clean-up utilities normally provided with standard operating systems and executable from local nodes connected to the network. In this case, after a virus has been detected in activity associated with a particular node for example, the infected mode can be remotely commanded to delete any copies made of the offending file, any history (HTML) shortcut that was retained in a history file, and any cookies associated with the URL sourcing the virus using the normal OS utilities adapted for the purpose and that otherwise would only be executed by an operator or a task scheduler.

In line with TCP/IP reset capability of SW 120, connection data, IP address data, URL data, and domain name data can be retained and recorded into the appropriate “blacklist” database tables of SW 120 in the event of virus detection so that future attempts by affected network nodes to access the original source from which the virus was contracted can be reset, thereby denying service to any node making a SYN request to the now banned destination.

Application module 205 has an e-mail client 212 provided therein and adapted, in a preferred embodiment, as an on-board, “vanilla” messaging client. E-mail client 212 is primarily adapted for the purpose of sending e-mail alert or notification messages to any other connected node on the local network. Such messaging is typically of the form of an automated e-mail or instant message alert sent to a connected node based on a trigger event like detection of a virus associated with that node, or detection that the node in question is attempting to engage in some banned activity.

In one embodiment client 212 may be a simple API to a host-based e-mail or messaging application. The goal of the API if provided in place of an on-board client is the same. For example, if a virus has been detected on one of the host machines while an operator was away, an automated e-mail alert may be sent to the operator advising him or her to run standard virus software as a precaution to make sure the virus detected did not infect any other applications other than the file that it had infected. Client 212 is in a preferred embodiment configurable by an administrator or other authorized individual through a GUI interface to SW 120, which will be described further below. Such configuring may include creating canned messaging scripts, configuring trigger events, setting window and text preferences, and so on.

A notification/data logging component 213 is provided within module 205 and is adapted to generate notifications and alert messaging to be sent to host machines using client 212 based on threshold trigger or activity event. The data logger portion of component 213 logs all data that is configured to be logged such as virus detection activity, resolution activity and results if any, new connections discovered, new IP hosts, new MAC hosts, and so on.

Module 205 has a parsing component 214 provided therein and adapted to parse specific types of data. Component 214 is logically represented in this example with multiple parsing functions. For example, a parsing capability is provided for HTTP packets, for TCP packets, for DNS packets, for HTML content, and so on. Component 214 therefore logically represents all parsing capabilities of SW 120.

A graphics user interface (GUI) Web server application is provided within module 205 and is adapted to serve as a user interface analogous to a Web interface for performing configurations, administrative functions, database maintenance functions, and so on. GUI 215 is accessible from any node connected to the local network through URL, as is the case with any standard HTML server. Access might be restricted in certain cases by requiring user authentication over a secure socket layer (SSL) or a similar regimen.

Processing module 202 has a fast pattern search engine 216 provided therein and adapted to detect virus patterns during network activity for all machines under the domain of SW 120 on a local network. Engine 216 creates hash values from data streams and compares those created values against a sparsely populated hash table. Each virus signature is “keyed” by creating a unique hash value for the signature then storing that value as a pointer entry. As hash values of a same length are created from active data streams, the values are compared against the table to see if any matches a pointer entry. If a hit occurs, the subsequent data packet or packets of the stream that contained the “hit” value are compared against the actual virus pattern to confirm a match.

Engine 216 is governed by algorithm and utilizes a novel multi-window sliding checksum technique to process packet data on the network. Engine 216 operates continuously during network activity and performs in the background using RAM memory analogous to RAM 204 of FIG. 2A. Engine 216 protects all local machines connected to the network and designated under the domain of SW 120.

Engine 216 enables SW 120 to detect virus signatures that might avail themselves through activity by any node connected to the local network. Engine 216 cooperates with scanner 211 to provide a detection method and, in some cases cleaning or killing of viruses. The virus detection method of SW 120 can replace normal virus detection software that might otherwise be distributed to each node on a local network.

A network driver 218 is provided as part of processing module 202 and is in a preferred embodiment, an Ethernet network driver. SW 120 leverages Ethernet functionality and driver 218 is analogous to the standard Ethernet driver provided with an Ethernet network card. Every node on the network has an Ethernet card and therefore, an Ethernet driver. SW 120 uses the Ethernet driver to enable many of its functions. Network driver 218 may be any other type of network driver provided that it supports an equivalent to P-mode functionality.

A TCP packet inserter 219 is provided within module 202 and is adapted to generate and insert TCP reset packets or, in some cases FIN packets into a data stream conducted between any two nodes in communication as long as one of the nodes is connected to the local network. On an Ethernet network, which is a preferred example for practice of the present invention, a data packet is referred to as a frame. Module 219 has capabilities of creating a packet header containing all of the parameters known about a particular connection such as source and destination IP address, source and destination MAC address (Ethernet), source and destination port address and TCP sequence number. A created TCP packet can include a payload field of data as well. Such data may include Java Script, an embedded command function, or other data that instructs a recipient of the packet to perform some action. Insertion of the packet or frame occurs such that the frame mimics the origin of the sender and is received as a trusted frame containing a correct sequence number.

TCP reset action can occur according to any triggering event like a host attempting to form a connection with a banned server, for example. Detecting a virus may trigger a TCP reset operation. Reset frames may also be inserted in an active session to kill unwanted pop-up advertisements. Several use-case embodiments illustrating cases for inserting TCP packets are described later in this specification.

A DNS/UDP packet sub-server 217 is provided within processing module 202 and is adapted to intercept certain DNS request packets that are addresses to a DNS server citing a pre-defined name known to SW 120. Sub-server 217 can generate DNS reply frames that mimic normal DNS replies sent from a DNS server. The purpose of this sub-server module is to enable a local network administrator to provide shared resources for network access whereby such resources need no DNS registration.

Database access (DBA) module 203 has a database (DB) look-up component 221 adapted to enable applications, modules, and human entities to search database information using structured query language (SQL) or other machine-based query language. A data reader/writer 222 is provided within module 202 and is adapted to enable reads and writes associated with data updating. Component 222 represents this capability both applied to static host-based storage and RAM temporary storage. At boot time a specific amount of RAM memory is acquired from the host RAM by software 120. Pre-configuration of SW 120 contains an option for setting the amount of RAM that will be acquired and dedicated to Buster operation during runtime.

A plurality of database (DB) tables is illustrated in this example as a grouping labeled DB Tables. Within DB tables there is listed a table 224 for blocked or banned domain names; a table 225 for listing virus signatures; a table 226 for listing IP connection tuples compiled during network activity; a table 227 for listing blocked or banned IP addresses; a table 228 for listing blocked or banned URLs; and a table 229 for listing blocked or banned communications ports; and a table 230 for storing bitmap images of machines connected to the local network. These tables, except for connections table 226, are all stored in permanent memory on the host node of SW 120 and are loaded into RAM memory when SW 120 boots up so that they may be accessed in the background without taxing OS resources.

Additional data that might typically be stored in a database table includes MAC host parameters of all of the machines currently part of he local network that have an Ethernet card installed. A table may also be provided for storing content filters used to filter certain type of content such as e-mail Spam for example.

In one embodiment all of the above-mentioned DB tables are permanently stored on the hard disk of the machine hosting SW 120. In another embodiment of the invention, they may be hosted in flash memory, or on another type of storage device connected to the local network such as an optical storage disk, a raid-array, a server, or legacy system. There are many possibilities.

A typical MAC hosts database (not illustrated) for providing the parameters of Ethernet machines connected to the local network is configured as a searchable hash table and contains, in a preferred embodiment, from as low as 5 entries up to 5000 entries depending on the perceived size of the local network. The entry number is a configurable number and may exceed or be less than preferred limits.

Blocked Domains table 224 is indexed by DNS names and is configured as a searchable binary tree. Domain names that are known to be sources of undesirable content such as pornography, gambling interfaces, spy ware sources and so on would make this list. When any machine on a network attempts a request for one of the banned domain names, SW 120 can interrupt the connection machine and deny access to the requested domain.

Virus table 225 currently contains about 8000 virus signatures. Table 225 is searchable by a hash table and indexed by virus signature pattern. Fast pattern search engine 216 described with reference to FIG. 2A uses table 225 to search for virus patterns on continual bases as long as the machine hosing SW 120 is running and there is activity on the local network. Table 225 is updateable in an automated fashion as new viruses are discovered. In a preferred embodiment each known virus is hashed using a specific portion of the virus string that uniquely identifies the virus. In some cases, similar viruses may have the same hash value if their strings are very similar. Table 225 is sparsely populated to aid in speed of searching. A unique method for hashing data and comparing those hash values against the hash values in table 225 will be described later in this specification. During runtime all of the virus patterns are uploaded to RAM. Updates can be performed on the RAM database, which can be offloaded to permanent storage on a periodic basis.

Database 226 contains connection information representing TCP/IP source/destination connections. These connection entries are formed on the fly as connections form on the network, and contains at least an IP source address, an IP destination address, a TCP source port, a TCP destination port, a TCP sequence number for a local machine (Ethernet) and a TCP sequence number for the remote machine. These fields are populated as the connections are formed and completed connections are temporarily stored in RAM. However, a known connection can be monitored for content and can have one or more parameters (IP address, port address) listed as banned as a result of activity or content that is undesirable. In some embodiments a formed or forming connection may be discovered to contain one or more parameters already known and banned such as a particular IP address or port listed in a blacklist. Table 226 is formed during runtime and has a specific lifetime associated with it. That is to say the connections are not permanently retained. Rather each connection discovered has a time to live (TTL) specified at boot-up. A period of few hours is a typical TTL for a discovered connection. Table 226 is indexed by IP address and port address and searchable by hash table. A typical number of entries will range up to 5000.

Table 227, containing blocked IP addresses, has a preferred size (# of entries) of 15,000. Table 227 is indexed by IP address and is configured as a searchable binary tree. Entries for table 227 may result from any known list of controversial IP addresses including any from the connections table that are judged to qualify as a blocked address.

Table 228 of blocked URLs is indexed by URL string and has up to 15,000 entries. Table 228 is configured as a searchable binary tree. Path names and paths referring to undesirable ads, spy ware, sexual content, gaming sources, etc. may be stored in this list.

Table 229, containing blocked ports, has a size of up to 15,000 entries and is configured as a searchable binary tree indexed by port number. As with the IP address table, ports may be added to this list from the connections database after monitoring results in suitable judgment that a port should be blocked.

Table 230, containing MAC images, is unique in that it stored bitmap images of all types of machines that may connect to the local network. The scheme uses a fact that Ethernet MAC addresses are burned into each card for each type of machine. Data is stored in table 230 that identifies, for example a machine manufacturer of Ethernet enabled machines and a range of addresses provided for a particular number of the manufactured machines. If a company produces a number of routers having Ethernet cards provided therewith, then all of those routers will fall within the range of Ethernet addresses assigned and burned into the cards. Knowing these parameters enables a network administrator to see at any time, the mix of machines that are operating on the network by visualizing its bitmap image.

For desktop machines a desktop icon is associated with the range of addresses for those desktops. For routers, a router icon is associated and so on covering a range of possible machine types. Whenever any machine type connects to the local network, SW 120 identifies the machine type by comparing its Ethernet address to the database, which brings up the appropriate bitmap image displayed in a visual format on a GUI used by the administrator.

It will be apparent to one with skill in the art that SW 120 may be provided in a form that resides on a desktop machine, a router, or in a dedicated hardware device without departing from the spirit and scope of the present invention. SW 120 can monitor and protect all of the other nodes under the domain of the local network. In some embodiments wherein a network is divided to form more than one network segment, more than one instance of SW 120 may be provided (one per segment). No other machines connected to a local network segment require any software installation related to SW 120 in order to gain network protection. However, in some embodiments, client applications for configuration of services, setting of preferences, and even manual interfacing with main SW application 120 can be provided. For example, a client interface may be distributed to all machines so that an administrator may access the main application including database information from any connected node.

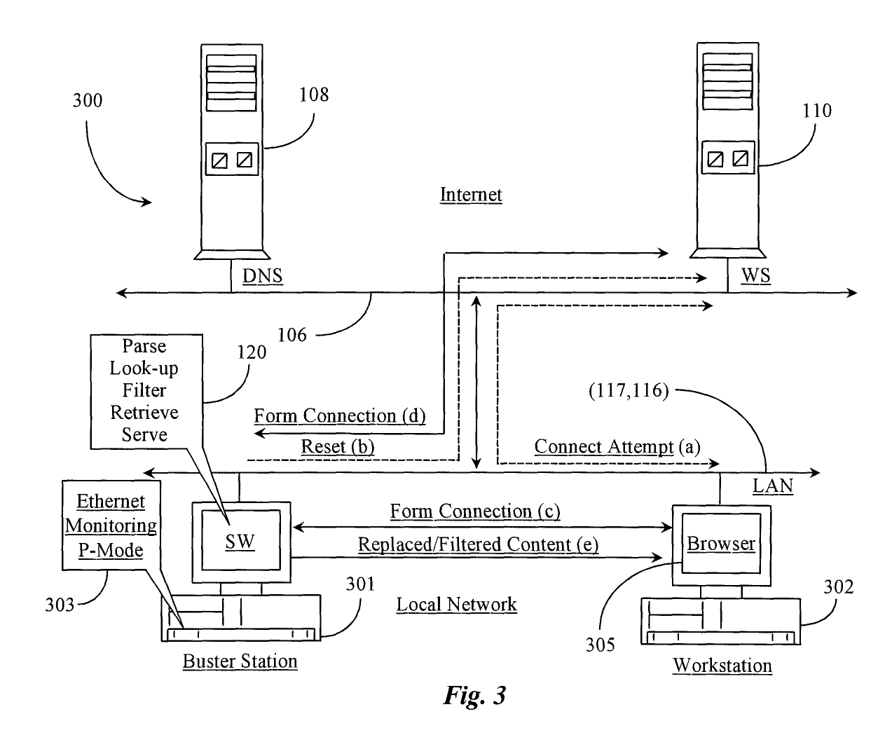

FIG. 3 is a network overview 300 of a process for filtering and/or replacing content ordered from a Web server according to an alternate embodiment of the present invention. Overview 300 represents a local network segment represented herein by LAN (117, 116) described with reference to FIG. 1 above and the well-known Internet network represented by backbone 106, also described with reference to FIG. 1. Elements that have been previously introduced and that are not changed in this embodiment shall retain their original element numbers. New element numbers are given to some common elements because of their introduction into a particular use embodiment.

Backbone 106 supports DNS 108 and WS 110 as was illustrated with reference to the example of FIG. 1. The local network segment 117 or 116 has 2 desktop nodes illustrated as connected thereto. These are a Buster station 301 and a protected workstation 302. In this example, an illustrated station 301 is analogous to either station 114z or 113b described with reference to FIG. 1. Station 301 has an instance of SW 120 (dialog box 120) provided thereto and is monitoring network segment traffic using a P-mode monitoring process illustrated herein as a process 303.

In this example an operator using a connected station illustrated herein as station 302 attempts to connect to WS 110 using a browser application illustrated as browser 305 running on station 302. In this case, WS 110 is not a banned server, however WS 110 is pre-known by SW 120 to serve or grant access to some content that is deemed not appropriate for the operator of station 302 to access.

The connect attempt by station 302 to WS 110 is represented herein as a step (a) labeled Connect Attempt and also by a double broken arrow to illustrate that a connection was not completely formed during the attempt. Using P-mode process 303, station 301 recognizes connect attempt (a), for example when station 301 sends a SYN packet requesting the connection. Rather than allowing the connection to form, station 301 with the aid of SW 120 generates a TCP reset packet and sends it to WS 110. In this example, station 301 inserts itself as a proxy and forms connections with station 302 and with WS 110. For example, after resetting server 110, station 301 forms a connection (labeled herein as double arrow (c)) with station 302. Station 301 duplicates the connection parameters offered by server 110 so that the formed connection is transparent to station 302. Station 301 then opens up a second and separate connection (double arrow labeled (d)) with server 110 using its own IP address.

Although labeled steps (c) and (d) in this example, the steps happen almost simultaneously and encompass the same TCP handshake routine that was thwarted at the point of WS 110 by the sending of TCP reset (b). Now station 302 has a client/server relationship with station 301 (sever) and station 301 has a client/server relationship with WS 110. In a preferred embodiment, the connect attempt (a) is not interrupted until server 110 sends a SYNACK packet containing parameters used by station 301 to establish connection (c).

Station 302 accepts station 301 as a trusted source with no indication that it is a proxy. With the connections formed between station 301 and 302 and between 302 and WS 110, SW 120 is leveraged to replace or and filter Web content from server 110 and to forward the resulting Web data to station 302 throughout the life of the Internet session. Filtering Web content can be accomplished using a variety of standard Web data filters. New Web content, such as a replacement HTML document can be retrieved from storage and served in place of a requested HTML document. Generally speaking, SW 120 performs parsing to determine the immediate content being served by WS 110. A look-up operation determines whether parsed content will be replaced or filtered. If the content should be filtered then one or more filter operations filters the data to be served. If replacement of content is performed, then SW 120 retrieves HTML content from RAM and serves the replacement content as if it originally was sourced from WS 110.

Station 301 continues to sniff all data packets entering the network for viruses during the proxy activity. Further, station 301 may reset more than one server connection attempt and insert itself as a proxy in more than one communication path involving more than one node local to the network as long as suitable bandwidth exists or is reserved to support the active communication paths over the shared network.

Referring now back to FIG. 2B, TCP packet generation and insertion is performed with the aid of module 219. Because connections data is formed on the fly, SW 120 waits until sufficient data is known about connect attempt (a) of FIG. 3 before resetting server 110. In this way, station 301 becomes a transparent and trusted source to station 302. Station 302 therefore requires no configuration for using a proxy server.

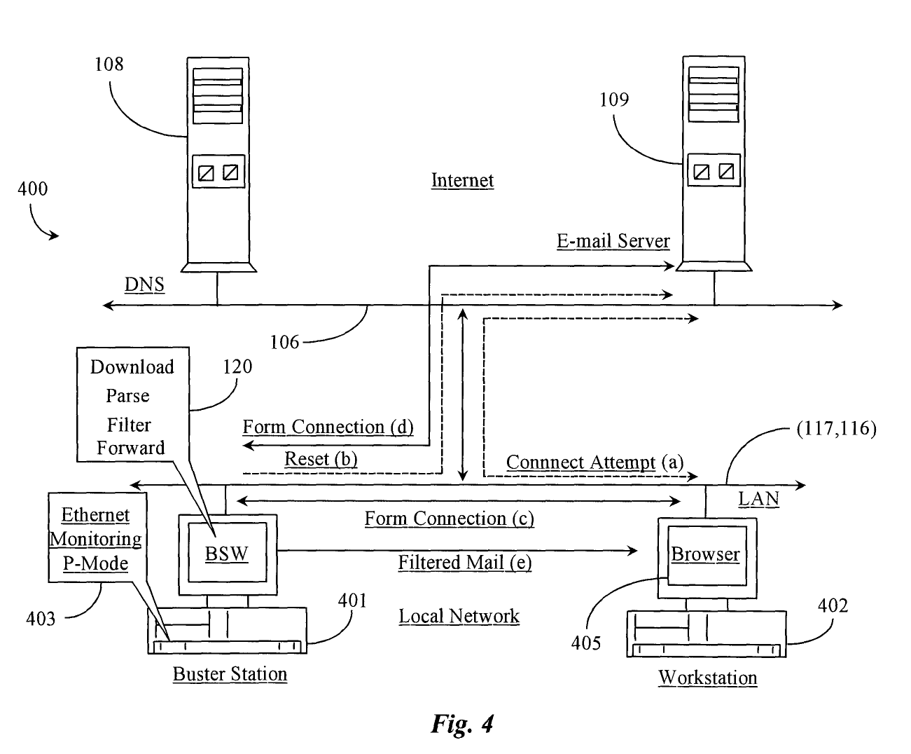

FIG. 4 is a network overview 400 of a process for cleaning e-mail ordered from an e-mail server according to an alternate embodiment of the present invention. Overview 400 is similar to overview 300 of FIG. 3 accept that Web server 109, which is an e-mail server replaces server 110. In this example LAN (117, 116) connects a buster station 401 running SW 120 and a workstation 402 running a browser application 405. Stations 401 and 402 are analogous to stations 301 and 302 described with reference to FIG. 3 above. New element numbers are provided only to show stations practicing an embodiment separate than that described above.

An operator at station 402 utilizes, in this case, browser 405 to attempt to download e-mail from e-mail server 109. The attempt is labeled connect attempt (a). Buster station 401 running SW 120 detects the connect attempt (SYN and SYN ACK) using P-mode monitoring process 303 and generates a TCP reset packet. Station 401 sends the packet to e-mail server 109 to deny completion of the connection between station 402 and server 109. The send action is illustrated herein as a broken arrow labeled Reset (b).

Station 401, after sending the reset packet, forms a connection with station 402 illustrated herein by a double arrow labeled Form Connection (c). Formed connection (c) is a trusted connection as far as station 402 is concerned. Station 401 also forms a separate connection with server 109 using its own IP address. This connection is represented herein as a double arrow labeled Form Connection (d). The process for forming the necessary connections for inserting itself as a proxy are identical to those described above with reference to FIG. 3.

Once the connections are formed, station 402 has a client/server relationship with station 401 and station 401 has a client/server relationship with server 109. In an example of e-mail, server 109 presents a generic login HTML to station 401, which then serves it to station 402. The user at station 402 supplies a username and password and sends to station 401 for authentication. Station 401 forwards the login request to server 109, which authenticates the user information and begins transmitting e-mail and any attachments to server 401.

Server 401, with the aid of SW 120 downloads the e-mail parses and filters the mail to separate Spam or junk mail and forwards the clean mail to station 402 as is illustrated herein by a single arrow labeled Filter Spam (e). It is noted herein that SW 120 may also be used to scan attachments of downloaded e-mails. All of the Spam mails and any attachments blocked by the filtering process are deleted. Only filtered mail and attachments are forwarded to station 402. In the background of this process, virus scanning is performed on the data packets involved in the instant connection in addition to those packets of other active connections. If a virus is detected in any data packets associated with the proxy connection, a TCP reset packet not illustrated is sent to server 109 to immediately break the connection. It is important to note in general that when a station sends a reset to one participant of a TCP connection, some data is also sent to the remaining participant. This function simply causes the remaining participant to increment the TCP sequence numbering of the connection so that if the receiver of the reset packet responds with a TCP reset packet back to the remaining participant the packet will be ignored.

In another alternate embodiment station 401 is acting as a proxy and is physically downloading the mail from server 109 on behalf of station 402 as in this example. In this case SW 120 may, alternatively, leverage a machine-hosted virus program not illustrated to scan the mail and attachments using a “scan incoming mail” option and normal kill, repair, and quarantine options if a virus is detected.

Because SW 120 sees all data packets on the local network, computing the correct sequence numbers to use in TCP reset packets is possible and practical. For example, the correct sequence number in any given point of transacting, an ACK packet for example, is always the sum of previous sequences and the amount of un-acknowledged data.

In one embodiment of the present invention, client nodes connected to the local network may have their own set of e-mail filters stored in the RAM memory of SW 120 at boot time. In this way certain client preferences can be observed. It is noted herein that the software of the present invention may also be configured to send TCP FIN packets instead of TCP reset packets to one or more connections. The decision of which type of packet to send at which stage of forming a TCP connection, including a completed TCP connection is based on the instant use case. For example, a TCP FIN packet is sent to inform the receiving machine that the sending machine is finished sending data. However, the recipient of the FIN packet can still send data. Therefore, if you want to stop the server side of a connection from sending any more data then a TCP reset is optimum.

Preferred embodiments for content insertion and content filtering and e-mail scanning and filtering will be described later in this specification.

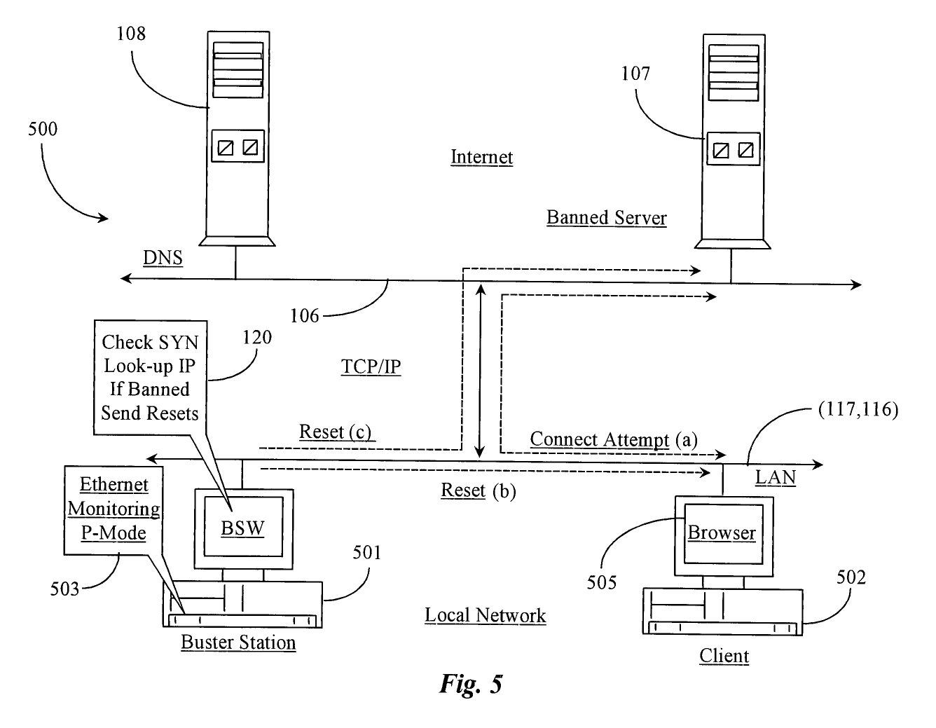

FIG. 5 is a network overview 500 of a process for denying a network connection between a network client and a banned server according to an embodiment present invention. Overview 500 represents an attempt to contact a banned server followed by a service denial of the requested connection. In this simple use-case, an operator at workstation 502 tries to connect to a known banned server (server 107) using a browser application, illustrated in this example as browser 505.

A station 501 running SW 120 uses P-mode monitoring process 303 to detect a SYN packet sent from node 502 to server 107. The request for synchronization includes the source and destination IP addresses. The connection attempt is illustrated herein as a broken double arrow labeled connect attempt (a). SW 120 cooperating with P-mode monitoring detects the first SYN packet and checks it against one or more databases for IP address status of the destination IP address. If the particular IP address of server 107 is banned and listed, immediate reset packets are sent to both participants in the connection. Rather when a SYN packet is detected through P-Mode it is handed off to SW 120 to check the destination IP address number against a list of banned IP addresses and/or ports uploaded to host RAM when the system boots.

If the IP address or banned port is listed then immediate TCP resetting commences with station 501 sending reset (b) to station 502 and reset (c) to server 107. Although the client's endpoint of the connection may technically form (as measured by the receipt of the SYN/ACK packet), it does not survive long enough to deliver any data. SW 120 simply denies service to station 502 by resetting both connection ends effectively killing the would-be connection. Because there is no proxy function required, SW 120 can monitor and act on the behalf of all network-connected machines sending SYN packets to banned IP addresses. It is noted herein that any parameter that is detectable when a local node sends a SYN packet can be listed in one of the databases as a banned parameter. In this example the banned parameter is an IP address; however ports and port/IP address combinations may also be listed as banned. The TCP reset packets sent in steps (b) and (c) are generated and delivered using module 219 of FIG. 2B through communication stack 206 also described with reference to FIG. 2B.

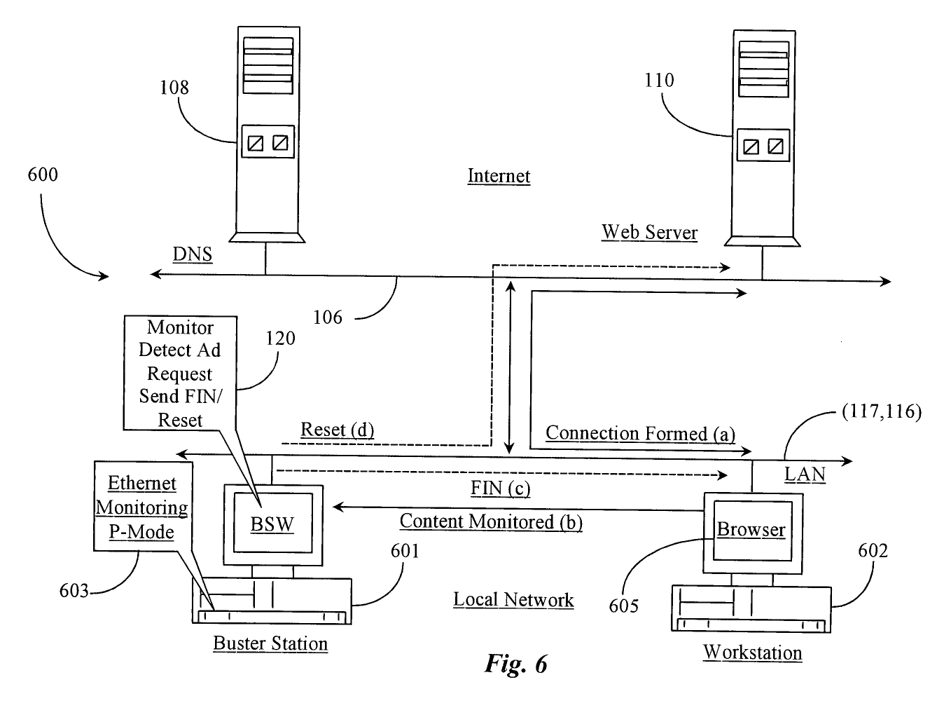

FIG. 6 is a network overview 600 of a process for monitoring a working connection and then eliminating TCP browser connections associated with unwanted Pop-up advertisements according to an embodiment of the present invention. Overview 600 includes DNS server 108 and Web server 110 connected to backbone 106 on the Internet side. In this use-case example, an operator using a workstation 602 forms a TCP/IP connection with WEB server 110 using a browser application 605. The connection formed is illustrated herein as a double arrow labeled Formed Connection (a). Server 110 is not listed in this embodiment as a banned server and there are no detected connection parameters of connection (a) that are listed as banned. Therefore, a workstation 601 running SW 120 allows the connection to be formed completely and to begin transferring data using the typical Hyper Text Transfer Protocol (HTTP) request response format.

It is well known that when a browser downloads Web-content over an Internet connection, a plurality of TCP connections are used by the browser application for populating the browser window with the various types of content such as text, graphics (including video) and audio. These logical connections operate simultaneously according to available bandwidth. For example if there is enough bandwidth, there may be as many as 12 or more separate TCP connections for downloading content. This content downloading scheme is well known in the art and utilized by all browser applications. If there are two main TCP/IP connections active for one computer (two open and active browser windows) then the number of available TCP connections dedicated to separate types of data is reduced proportionally.

Advertisements that appear in a new window while Web browsing are generally known in the art as pop-ups or pop-up ads. Pop-ups appear to a user as un-solicited content that seams to suddenly appear for no apparent reason. Rather, the active Web browser calls virtually all pop-ads by executing some code that is embedded into the Web content being downloaded and displayed. For example, clicking on a news headline may result in execution of an embedded code or link that launches a request the ad content. The active browser typically opens a new window as a container for the advertisement to be downloaded over a TCP connection and displayed in the window. Pop-up advertisements may be hosted by the server hosting the main TCP/IP server/client connection or may be inserted through a separate TCP/IP connection that is opened upon execution of the code calling a particular advertisement.

SW 120 has the capability of killing these unwanted advertisements by inserting a combination of reset and FIN packets into the active TCP/IP connection formed without actually terminating the active browsing session. With the connection formed between station 602 and Web server 110, SW 120 on station 601 uses P-mode monitoring process 303 to sniff the data packets associated with browser 605. SW 120 can detect when browser 605 executes an embedded code (executable) that calls an unwanted pop-up advertisement. The code identifies the TCP parameters of the connection for downloading the advertisement and also contains instructions for the Web browser to open a window container to display the advertisement.

In this case, the identified connection is not the main TCP/IP connection, but rather the specific and separate TCP connection that will be used to download and display the advertisement. When the embedded code is executed, the TCP connection is activated by the browser sending a request for the advertisement followed by an acknowledgement of the request and the sending of the ad data. If the ad data is large, it may take several sequences to complete the download. The browser code for opening the display window is typically executed ahead of transfer of the ad data.

SW 120, upon detecting execution of the ad request immediately generates a FIN packet and sends it to local station 602 indicating that server 110 is finished transmitting data over the TCP connection associated with the ad data. A broken arrow labeled FIN (c) represents the mentioned action. If FIN packet (c) arrives before any ad data is sent and more particularly before browser 605 has launched a display window then it is possible that the window execution code will be aborted by the browser since there will be no data to display in the window. At the same time browser 605 is free to continue sending data to server 110.

SW 120 generates a TCP reset packet and sends the TCP reset to the remote server to stop ad data from being sent over the particular TCP connection identified. This action is illustrated herein by a broken arrow labeled Reset (d). In effect reset (d) in this example mimics a request from browser 605 for the server to reset its TCP connection dedicated for the ad serve operation.

In some embodiments it may be that the execution of the display window for holding the advertisement display is executed before a FIN packet arrives at station 602. In this case the window will remain open but blank until a user manually closes it, which can be just as annoying as having the ad in the window. To resolve this problem, in one embodiment SW 120 has access to some pre-defined Java script stored in RAM that can be inserted into the payload portion of the TCP FIN packet. The script instructs the browser to close the window if it has already formed. In this way, Pop-up ads can be eliminated without affecting the main browser session in terms of other data being downloaded.

In one embodiment of the present invention, SW 120 can re-send FIN and reset packets repeatedly according to a timed sequence during a browser session wherein the embedded code soliciting an advertisement instructs the browser to request the ad at timed intervals for the rest of the session held at a particular URL hosting or sponsoring the ad. In this way even advertisement code programmed to repeat at timed sequences can be thwarted.

It will be apparent to one with skill in the art that TCP packet insertion can be used to kill any TCP/IP connection before it is actually formed or it can be used to restrict certain content from being downloaded by a browser application without killing a Web-browsing session. Further, in the latter embodiment, certain advertisements may be allowed in a session while certain other advertisements may not. For example, an administrator may consider allowing friendly advertisements sourced from non-competitors onto the local network but not advertisements sourced from known competitors. To effect this embodiment SW 120 parses the ad code and compares it to a list of friendly advertisers, or a “white list”. If the ad source cannot be identified in this list then the ad is killed. There are many possibilities.

DNS Enhancement

In one embodiment of the present invention a method for reducing manual configuration steps for domain name service registration is provided.

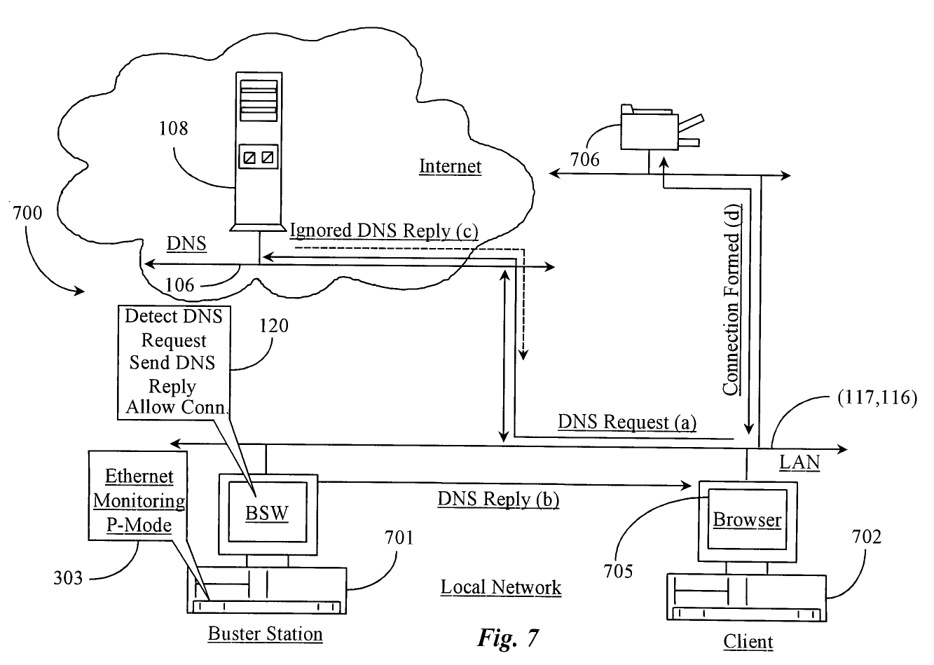

FIG. 7 is a network overview 700 of a process for Providing Domain Name Service functionality in an automated fashion using pre-defined names according to an embodiment of the present invention. Overview 700 comprises DNS server 108 connected to Internet backbone 106 within an Internet domain represented herein by a cloud icon labeled Internet.

Local network 117, 116 has a workstation 701 illustrated as connected thereto and hosting an instance of SW 120. Workstation 701 is labeled a Buster Station because it hosts SW 120 for protection of any other nodes including itself connected to the local network. A client workstation 702, labeled Client, is connected to local network (LAN) 116, 117 and is running an instance of a Web browser application 705. SW 120 running on station 701 uses P-mode process 303 to sniff all data packets on local network 116, 117 as described in previous TCP embodiments.

A shared resource, in this case a printer 706 is provided as an exemplary node connected to LAN 116, 117. Printer 706 is a shared printer accessible to all other nodes on the local network that have the capability of printing. Resource 706 is a printer in this example but may instead be any type of resource like a server, a software program running on a network node, or any other type of accessible data source or machine without departing from the spirit and scope of the present invention.

DNS is a well-known protocol for resolving IP addresses from registered domain names for nodes that are registered with the DNS service. A domain name is a URL string that typically presents a three-level “server.organization.type” format. The top level is the “type” organization, for example .com for commercial sites or .edu for educational sites. The next level is the top level plus the name of the organization, for example, clear2net.com. The last level identifies a specific host server at the address like a World Wide Web (www) server. A domain name is ultimately mapped to an IP address, but two or more domain names can be mapped to the same IP address. A domain name must be unique on the Internet, and must be assigned by a registrar accredited by the Internet Corporation for Assigned Names and Numbers (ICANN).

Most publicly accessible business entities, education entities, non-profit organizations, and the like have a domain name mapped to an IP address so that other nodes may contact and access the node over TCP/IP by entering just the domain name into a browser address bar. A DNS server analogous to server 108 in this example provides the IP address of any particular network node after receiving a DNS request containing the domain name of the node. The request is made from another node wishing to communicate with the node (typically a server). DNS servers are distributed database applications that contain the names, nicknames, and IP address data of all network nodes local to the server that have registered with the DNS system. DNS servers are assigned to local nodes but may poll other non-local DNS servers for IP address information on behalf of a requestor.

In this case printer 706 is a network printer designed for shared use on a local network like an Ethernet network, as is the case of this example. Printer 706 has a server component (not illustrated), which enables network access to printer 706 under a pre-defined domain name. As a network node, printer 706 has an IP address that can be assigned to it through DHCP functionality or by module 217 described with reference to FIG. 2B above.

In current art, whenever a network administrator connects shared resource onto a local network, the resource has to have a registered domain name entered into the DNS database and an IP address so that users can access the resource by sending a DNS request including the domain name of the resource whether it is a server, a printer, or some other accessible device. The method of this embodiment enables connecting of the resource to a local network without registering and entering a domain name for the resource.

End users can navigate to the resource by sending a DNS request just as they would a DNS registered device.

Printer 706 has a manufacturer. The manufacturer of printer 706 may pre-assign a nickname to a line of network printers for example. The pre-assigned name may be of a standard domain configuration or it may simply be a nickname like printer.1. SW 120 maintains a database of the nickname of printer 706 and its assigned IP address. The nickname printer.1 is published to all other local network stations that are authorized to have access to printer.1. In this case, the name printer.1 is not registered with the DNS service.

Client 702 can access printer.1 by typing the nickname into the browser address field and initializing a DNS request. This action is illustrated in this example by a single arrow path labeled DNS Request (a). The nickname printer.1 is in this case listed in a database maintained by SW 120 running on station 701. SW 120 has the capability of detecting any DNS requests from any local node like client 702 for example using P-Mode monitoring process 303, more specifically module 217 described with reference to FIG. 2B above, adapted to parse DNS packets. SW 120 intercepts any DNS requests that contain an “interesting” name such as “printer.1”. The selective mechanism can be programmed to ignore DNS requests having a standard domain name configuration but parse those having a nickname configuration that deviates from the norm. SW 120 then selects the packets using the deviant name constructions and compares those names against those held in a list of pre-defined names (not illustrated). SW 120 may also choose to compare the DNS names from all received DNS requests to its list of pre-defined names, skipping the step of identifying deviant name constructions.

In the above case, the name printer.1 is compared for match and if found causes a DNS reply packet to be generated at station 701 and sent to station 702, the reply represented as coming from DNS server 108. This is illustrated herein as a single arrow path labeled DNS reply (b). SW 120 sends DNS reply (b) before DNS server 108 sends a reply to original DNS request (a). This is possible because station 701 is local to client 702. Server 108 sends a DNS reply illustrated herein as a broken arrow path labeled Ignored DNS Reply (c), indicating that station 702 will ignore the reply from server 108 because it has already received and processed reply (b) from station 701. DNS reply (b) mimics the IP address of server 108 and is trusted by the requester (702).

DNS reply (b) supplies an IP address to the server component of printer 706. Station 702 then forms a TCP/IP connection to access printer 706 on the local network. This action is illustrated herein by a double arrow path labeled Connection Formed (d). By mimicking server 108 and sending a DNS reply containing the correct IP address information, an administrator can connect any number and mix of shared resources on any local network without having to configure DNS parameters. However, it is noted that these same resources are not known by the DNS system and cannot be accessed from a remote node not operating on the local network. Therefore, if an administrator wishes to give public access, for example to a resource connected to the local network then a DNS name must be registered for the resource. Still, for a large corporate LAN simply leveraging existing DNS protocol to enable configuration less connection of shared resources eliminates much work.

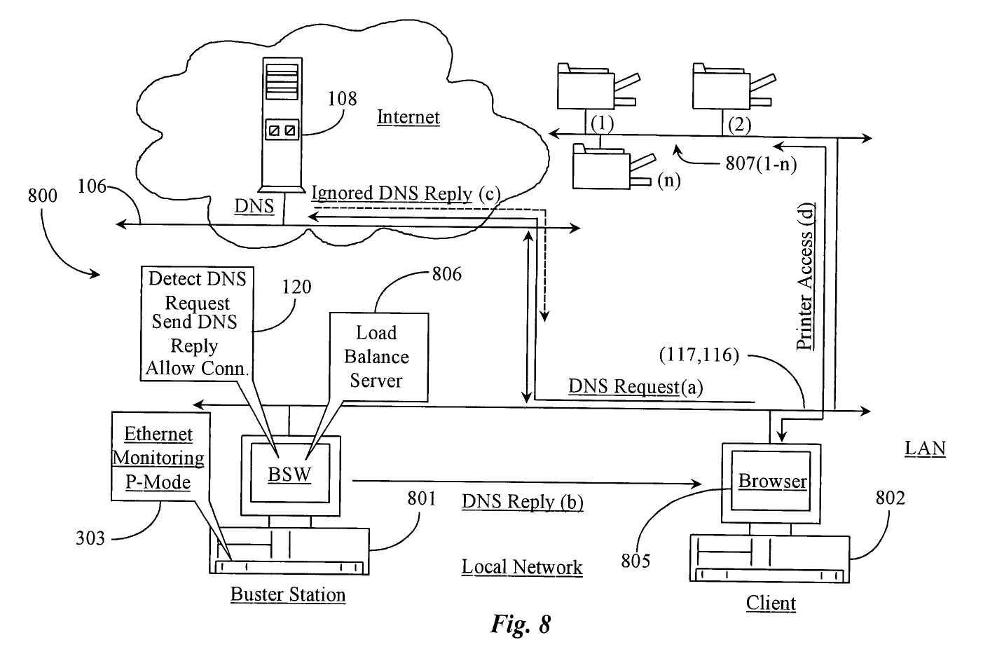

FIG. 8 is a network overview 800 of the process of FIG. 7 using a load server or load server mechanism to balance traffic between multiple IP addresses according to an embodiment of he present invention. Overview 800 includes DNS server 108 hosted within the Internet network, the network represented herein by a cloud icon. LAN network (117, 116) includes a client station 802 running an instance of a browser application 805 and a Buster station 801 running an instance of SW 120 and P-mode monitoring process 303. This overview is the same in description as overview 700 described with reference to FIG. 7 above in terms of DNS leveraging. A difference in this embodiment is that instead of a single shared resource (printer 706) a plurality of shared resources are provided. These resources are illustrated herein as printers 807 1-n for exemplary purposes only. Printers 807 1-n may be another type of shared resource.

An enhancement to this embodiment includes provision of a load-balance server illustrated logically herein as a load balance server 806 provided as a part of SW 120. Load server 806 is adapted as a traffic control server for providing optimum client access to any one of printers 807 1-n.

In this embodiment, printers 807 1-n do not require domain names or nicknames. Each printer 807 1-n does have an IP address. Load server 806 does have a pre-defined domain name or nickname like, for example Buster.1. A registered domain name is not required for server 806 to function on the local network. SW 120 stores the nickname Buster.1 in a data list adapted for the purpose when station 801 is started or at boot time. It is noted herein that server 806 may also load balance for other shared resources in addition to printers 807 1-n. Server 806 stores multiple IP addresses associated with the printers 807. In this embodiment one domain name (Buster.1) represents all connected printers. The multiple addresses are associated with the single domain name. Server 806 functions as a load-balance server in this case.

Client 802 sends a DNS request containing Buster.1, for example, to DNS server 108. This is illustrated herein by a single arrow path labeled DNS Request (a). P-mode 303 is leveraged by SW 120 to detect such a request, parse the request if not a standard domain name and then compare the provided name against the stored name Buster.1. If a request for “Buster.1” matches an entry in the database then SW 120 generates and sends a DNS reply (b) to requester 802. This DNS reply will contain the IP address of the particular printer 807 1-n that is ready and not busy serving another client. Server 108 responds with a DNS reply labeled herein as an Ignored DNS Reply (c). The reply is ignored because reply (b) is already received and processed. In any event, reply (c) will be an error reply as Buster.1 is not a registered domain name.

Load server 806 has a maintained record of which printers are currently busy and which printers are open. If all printers 807 1-n are busy then server 806 sends the IP address of the least busy printer in DNS Reply (b). Client access to an available printer is illustrated herein by a double arrow path labeled Printer Access (d). In this case, SW 120 consults load server mechanism 806 to determine which printer is most available or under the least load. The IP address of that particular printer is then inserted into DNS Reply (b). The current activity of all printers 807 1-n is maintained by server mechanism 806. The current data is obtained either by reporting or by monitoring and maintained in a resource load database (not illustrated) maintained in RAM. This data is consulted in the determination of which IP address to insert in a DNS reply.

In a preferred embodiment the Buster station 801 processes the DNS replies and maintains traffic control with respect to printer access. In another embodiment of the present invention, a network administrator may enhance DNS/UDP module 217 of FIG. 2B to assign local names to local nodes connected to the network. For example, the server could be configured with a list of local nodes to name at boot time. The names are assigned and then published to all local stations as domain names. Thereafter whenever any of the local station sends a DNS request for one of the pre-defined names for a resource, SW 120 inserts a DNS reply containing the correct IP address of the resource.

In still another embodiment Buster station 801 may function as a proxy station in conjunction with load server 806 wherein client stations wishing to access one of printers 807 1-n may actually form a TCP/IP connection with Buster.1 using the IP address of station 801. In this case clients may be queued for printer access on a first-in-first-out (FIFO) queue basis. As soon as one of the printers becomes available a redirect event is used to redirect the client to the open printer. There are many possibilities.

It will be apparent to one with skill in the art that the capability of inserting a DNS reply packet into a communication path enables services other than simple local resource configuration and access. For example, a particular DNS server may be judged as a banned server for reasons that can vary. Perhaps the server carries many banned domain names or IP addresses. Denial of service can be practiced whenever a local node attempts to send a request to the server. TCP/IP resets can be sent to both parties killing the connection attempt.

Fast Pattern Virus Detection

SW 120 has a capability of detecting virus programs and other malicious code that is about to enter any one of the local nodes connected to the local network. SW 120 is aided in this function by fast pattern search engine 216 described with reference to FIG. 2b of this specification.

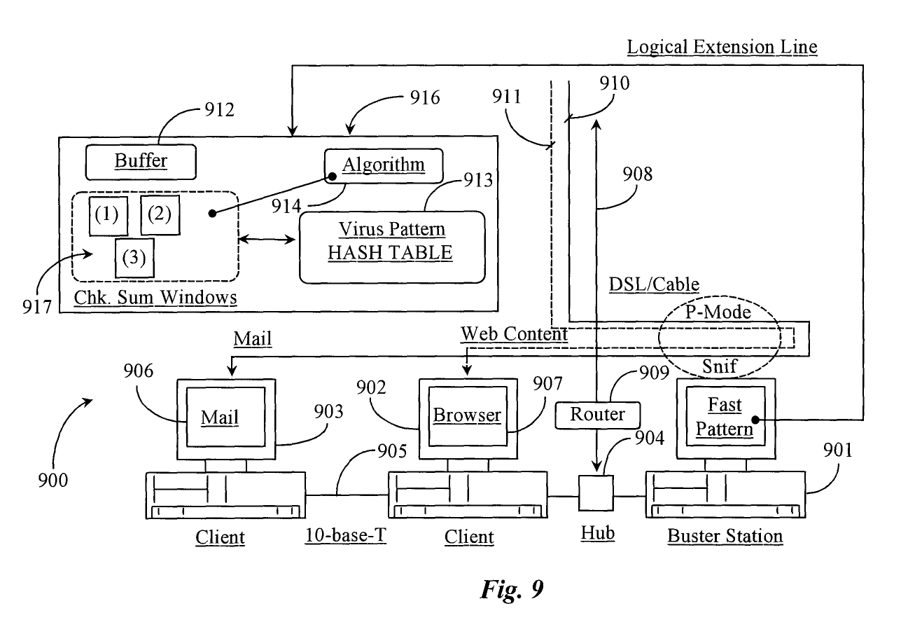

FIG. 9 is a block diagram illustrating a virus detection process 900 according to a preferred embodiment of the present invention. In this example, a search module given the element number 916 represents fast pattern search functionality. Module 916 is logically represented herein by a single arrow path extending from the screen interface of a workstation station 901. Station 901, also referred to herein as a Buster station, is the local network node that hosts the software of the present invention analogous to SW 120 described in previous embodiments.

There are two other stations illustrated in this example. These are a client station 902 and a client station 903. Typical Ethernet connectivity is illustrated connecting the mentioned workstations stations for communication via a 10-base-T cabling 905 including an Ethernet hub 904.

Hub 904 is not specifically required in order to enable an Ethernet network, as some configurations are hub less. Hub 904 in this example is connected directly to a router 909 that interfaces between the local network analogous to LANs 116 or 117 described with reference to FIG. 1 and the Internet network.

Access from the local network to the Internet is illustrated in this embodiment by a network access line 908, which is a DSL or Cable carrier. As was described with reference to FIG. 1 above, dial-up and wireless connections are also possible without departing from the spirit and scope of the present invention.

Client station 903 is actively engaging in the downloading of e-mail using a typical e-mail client 906, also labeled Mail. Client station 902 is actively engaged in browsing the Internet using a typical Web browser program 907, also labeled Browser. Data streams 910 (Mail) and 911 (Web content) are logically illustrated herein to show active data activity. In actual practice all packets travel on line 908 through router 909, hub 904 and to each recipient workstation.

Buster station 901 is running fast pattern search to check for viruses and other types of malicious code using P-mode monitoring as was described in earlier embodiments of this specification. P-mode monitoring enables engine 916, in this case, to sniff all data packets for both machines 902 and 903 as well as for any other nodes actively transmitting and receiving data on the local network.

Engine 916 utilizes a buffer memory 912, typically RAM, which temporarily stores data packets or frames while algorithm 914 is running in the background. Algorithm 914 calls for sliding checksum windows, illustrated herein as windows 917. In this case there are three windows 917 (1), 917 (2), and 917 (3). The fast pattern process involves creating hash values of a specified length or window of all incoming data streams. In a preferred embodiment of the present invention the length or window for hashing is every 9 bytes of data. The reason sliding check sum windows are employed is to speed up the process of hashing. More about the use of sliding windows 917 will be provided later in this specification.

As hash values are created from the incoming data streams 910 and 911, they are compared with a hash pointer index of a virus signature hash table 913, also labeled virus pattern hash table. Hash table 913 is sparsely populated and contains approximately 8000 virus signatures. Each virus string is hashed to produce a hash value that is representative of the most uniquely identifying 9 consecutive bytes of the virus data.

Fast pattern searching for virus signatures is a continual process that runs in the background of the machine host, or station 901 in this case. Station 901 looks at every packet incoming into the network. As hash values are created of the data frames coming in, those values are compared against a hash index of table 913 for a hit determination. It is noted herein that created hash values are rendered from consecutive data. A second algorithm not illustrated in this example, but described later in this specification resolves 9 byte windows that encompass more than one data frame.

When Buster station 901 obtains a signature match with the hash index table, an alert of virus detected causes at least an immediate TCP reset of both parties of the TCP connection responsible effectively killing the connection. In most cases the reset causes the executable to either fail in complete download or to at least be identified as corrupted with a virus. In the first case no eradication or cleanup is required because the receiving client will delete the portion of the file that contained the virus and as long as a complete executable file was prevented from loading execution and resultant launching of any virus would be impossible.

In the latter case mentioned above, if the file was small enough to completely download to the recipient station at least it is identified and an alert to the machine operator or even an automated machine-to-machine command from station 901 to the recipient station could contain instructions for eradicating the file containing the virus before it is executed. In case of a self-executable file, measures may be taken to isolate the virus to just the recipient machine where on-board virus eradication software can kill, repair, or quarantine the file containing the virus. In most cases, the local TCP reset packet effectively prevents the detected virus from fully entering the recipient's machine. It is noted herein that this process is performed not by proxy. That is to say that only copies of the data frames are sniffed by station 901 so it is not retaining frames as a proxy station might.

One station analogous to station 901 can handle a sufficient number of active nodes. If a network becomes to large for one Buster station in terms of number of machines, a second station can be added and the networked machines can be divided between the two stations practicing network segmentation.

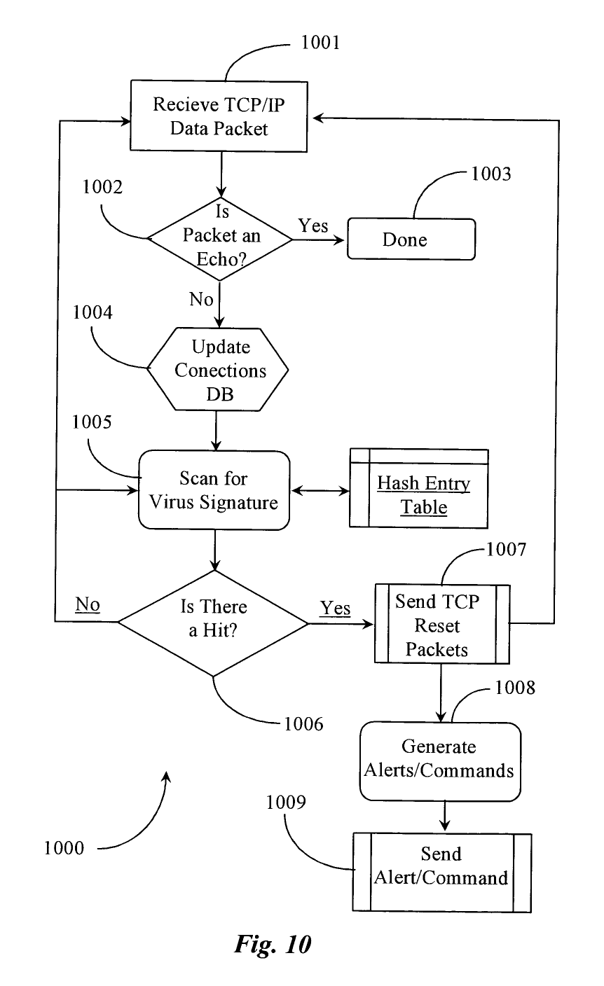

FIG. 10 is a process flow chart 1000 illustrating steps for detecting an incoming virus and resolving the potential threat according to various embodiment of the present invention. At step 1001, SW (120) receives a TCP/IP data packet containing a data payload as part of a current and active connection. Promiscuous mode enables SW 120 to see all packets, however TCP/IP packets with payloads or typically scanned for viruses. Address Resolution Protocol, (ARP), DNS over UDP, IP, and other typical control packets not known to carry payloads that may be infected with a virus are not necessarily scanned. It is noted herein however that the just mentioned packets other than TCP/IP payload packets are identified and data may be copied from them in order to keep the “connections database” up to date in real time in case a reset has to be inserted into the active connection.

At step 1002, SW 120 determines if the received TCP/IP packet is an echo packet that has already been processed. If the determination is yes at step 1002, then the processing is done for that packet. If it is a new TCP/IP packet then it is determined whether the packet is from an existing connection maintained in the connections database or whether it is a packet from a new connection. In either case, at step 1004 the connections database is updated with information that will be used if a reset packet has to be generated for insertion. For example, the packet IP and Port as well as TCP sequence numbering is stored. If it is part of a new connection then the new connection data is entered as an active connection.

SW 120 utilizes receive logic (RX logic) to sort and identify packet types during P-mode operation. More detail about RX logic is provided later in this specification. At step 1005, the TCP/IP packet is scanned for viruses. This process involves use of sliding checksum windows for determining (by algorithm) hash values on the payload data starting with the first byte of a 9-byte window. Use of multiple windows that operate simultaneously increases the speed at which hash values can be created from the data stream. That is to say that instead of computing each byte that is included in a next hash value all over again, the process saves the last computed hash value and uses that value to compute the next hash value based on the second checksum window position and then again for the third checksum window position. Each created hash is used to index a hash entry table wherein the hash entries each point to one or more virus signatures stored in the data portion of the database. The hash entry table is illustrated in this process as a repository icon labeled Hash Entry Table.

At step 1006, a determination is made as to successful or no comparison for each hash value compared against hash entries in the hash table. In the example below, there is a one in approximately 4000 chance that there will be a successful match. Therefore the standard determination is “no hit” for any particular hash value compared. It is noted herein that one TCP/IP payload may and likely does contain enough data to produce a plurality of hash values from the data. After a particular hash value is determined not to match, as long as there are still hash values from the same packet, they are compared also in step 1005. Assuming there will not be a match for data in the instant packet, the packet data is eventually exhausted and the process resolves to a next serial TCP/IP packet received for scanning. It is also noted herein that the hash creation and comparison process occurs simultaneously on all TCP/IP packets received regardless of the connection it belongs to. Therefore constant data hashing and comparison for a match is performed on and ongoing basis while the network is active and the host station is booted up.

If in step 1006, it is determined that a match exists between a particular hash value and an entry, the assumption is that a virus has been detected. The system does not attempt to validate the entire virus signature with subsequent hash comparison because of time constraints. Therefore, a hit results in immediate generation and send of TCP/IP resets to kill the TCP/IP connection identified as the host connection for the packet containing the matching hash value at step 1007. The reset operation uses the most recent connections database parameters stored for the connection to mimic the participant stations of the connection. In a preferred embodiment the recipient of the offending packet is reset first to avoid further download of data.

In a preferred embodiment, the reset action is fast enough to cause the data assumed to contain the virus to be prevented from entirely downloading onto the recipient station. In this case the virus is rendered incomplete and therefore not executable. In the preferred case it can be verified if the entire virus string was likely downloaded by referencing the known length of the hash value-associated virus string. If the recipient did not download the entire string then no further action is specifically required. The station that received the data will discard the incomplete downloaded portion. However, if the entire virus string was contained in the single data packet, which is very unlikely given the complex nature of virus strings, then the Buster station (SW 120) can generate an alert or command in step 1008 that specifies in the case of a command, a particular action to undertake or in the case of alert, instructions for an operator of the station.

At step 1009 the alert or command of step 1008 is sent to the recipient station one or a combination of communications protocols. In the case of generating a command, the command can be a machine-to machine command to a program client installed on the recipient station. For example, the client might be a management utility adapted to immediately delete the referenced file and any history information of URL links to the source of the reference file. In one embodiment, the client is an on-board virus program adapted to listen for a command to launch a virus repair, quarantine, or kill operation designed to destroy the detected virus or file containing it. Remote Call Procedure (RPC) or some other known machine-to-machine protocol can be used to deliver the command, which executes regardless of the presence or no of the machine operator as long as the station is online.

In the case of alerts to a machine or station operator, a vanilla e-mail application analogous to e-mail module 212 described with reference to FIG. 2B above is used in one embodiment to deliver an alert message through e-mail that informs an operator of the virus detection and reset operation that has occurred and includes any instructions for further action to be undertaken by the operator.

In another embodiment of the present invention, a pop-up alert can be sent to the virus recipient via instant messaging or some other message application. There are many possibilities.

It will be apparent to one with skill in the art that process 1000 may contain additional steps including sub steps without departing from the spirit and scope of the present invention. For example, step 1007 includes sub steps of filling in packet header fields with the correct data from the connections database and performing such routine functions as performing a checksum before send and appending the TCP and IP header information.

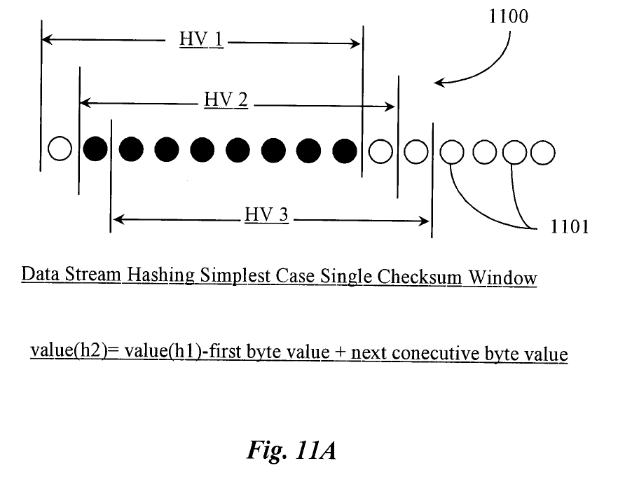

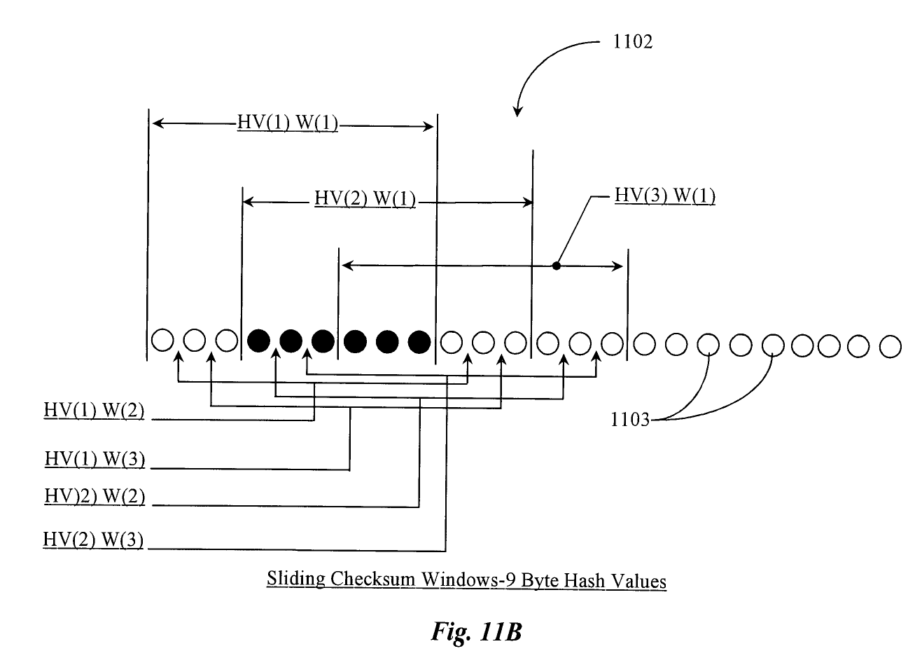

FIG. 11A is block diagram 1100 illustrating a hashing operation on a data stream according to a simplest embodiment of the present invention. Diagram 1100 is intended to represent a partial data string of a TCP/IP frame or packet payload of consecutive bytes illustrated herein as bytes 1101. As previously described above a checksum window creates a hash value from 9 consecutive bytes of data in a preferred embodiment, although any byte length may conceivably be used to represent a hash value as long as it is the same length each time.

In a simplest embodiment only one sliding window is used to create hash values. A hash value is created starting with the first byte of a payload unless a previous hash on the last consecutive data payload in a prior frame was not completed because there were less than 9 bytes left in the payload.

In this case the first 1 to 8 bytes may belong to a window started in the previous consecutive packet. However, for the purpose of explanation and clarity, we will assume that the hashing begins with the first byte of a given data frame payload.

A hash value 1 labeled (HV1) is illustrated in this example and represents a hash value computed from the first 9 bytes of the data string using a single sliding checksum window of a length equal to 9 bytes. HV1 is then immediately compared against the previously described hash table entry. As soon as HV1 exists, a hash value 2 is computed the window sliding one consecutive byte over. HV1 is temporarily stored when computed and then recalled to expedite computation of the second hash value as follows: Value (h2)=value (h1)−the first byte value (reversed checksum of the first byte of the last value)+the next consecutive byte value of the data string. The portion then of HV1 that does not have to be recomputed is shaded black in this example. The use of this technique expedites hashing because relevant bytes from the previous hash value are not recomputed. A next consecutive window HV 3 is illustrated in this example for creating the third hash value sliding one consecutive byte over from HV2.

In prior art a general fast pattern searching method is known to the inventor and referenced herein as a technical paper entitled “A FAST MULTIPLE STRING-PATTERN MATCHING ALGORITHM” authored by Sun Kim and Yaggon Kim, the reference referred to hereinafter as Kim and Kim. Kim and Kim describe a general approach for searching character strings by conventional hashing. However, in Kim and Kim, each byte of subsequent data must be re-summed for every byte included in a given window.

The fast search pattern of the present invention also expedites searching by using a bit-masking technique to diminish the size of the hash table index. For example 8000 virus signatures can be searched using only 4 MB of memory for the index. Moreover the method of the present invention includes loading the hash table into RAM at boot to further accelerate searching. The fast pattern search method of the present invention further accelerates searching by using multiple staggered checksum windows that operate simultaneously on the data being hashed.

FIG. 11B is a block diagram 1102 illustrating a hashing operation on a data stream according to a preferred embodiment. Diagram 1102 represents a data string of consecutive bytes 1103 as described above with reference to FIG. 11A. In this example, HVI, HV2, and HV3, of FIG. 11A are illustrated above consecutive bytes 1103 having been hashed by a single sliding window W (1). In addition to W(1), a W(2) and a W(3) are also at work on the same data string.

Assuming that HV(1) W(1) begins with the first byte of data as is illustrated herein, HV(2) W(1) begins 3 bytes over. It is noted herein for convenience in processing that each 3-byte portion of data is treated as a single 24-bit number. The portion of HV(1) that does not have to be recomputed is illustrated as shaded black in this example. For each window then, the first 3 bytes of the last value are reversed in computation and the next three bytes of data are added into the computation. As can be seen in this example, HV(3) W(1) begins another three bytes over.

At the same time that HVs (1-3) are being computed by W(1), W(2) and W(3) are also computing hash values as illustrated by bracketed arrows placed underneath bytes 1103. For example, HV(1) computed by W(2) begins processing one byte over from W(1) HV1. W(2) then computes HV2 for W(2) at 3 bytes over from HV1 W(2). Likewise, W(3) begins computing its first hash value staggered one byte over from W(2) position computing its HV(1) or first hash value. HV(2) of W(3) is staggered 3 bytes over from HV(1) W(3) and so on through out the data string. Because there are 3 operating checksums in this embodiment all processing hash values, there are three separate temporary storage fields in RAM for storing the immediately previous hash values for each window so that the second value for each window is expedited. When a hash value is no longer needed it is dumped by the system.

The computation parameters for creating the hash values can vary somewhat without departing from the spirit and scope of the present invention as long as the first byte computation, or first 3 byte computation depending on the number of checksums operating is reversible mathematically from the previous hash value for each window. There are many possible schemes that can be employed building on a simplest case of adding the byte values within the window. The fact that three checksum windows are utilized in a preferred embodiment should not be construed as a limitation of the present invention. More than three or less than three checksum windows can be employed. The use of 3 windows is deemed adequate by the inventor in an environment where hash values in the range of 0-32M are desired.

The exact number of sliding checksum windows used and the computation unit employed (in this example, 3 byte unit) will dictate the maximum value of the hash index. The desired size of the hash index is at least 32M. A three byte-summing unit for example, will yield a hash index that is significantly larger than 32 M or more than enough for a virus application.

An exemplary code and inserted explanation of components and procedures thereof is provided immediately below. One with skill in the art will readily understand the fast pattern search code as practiced in a preferred embodiment by reviewing the code in the context of the added comments.

Fast Pattern Code Example

```
#define SUMS 3
/* br_patscan( ) - scan passed data for a pattern
  *
  * Current virus database is represented in the external array
  * pattern_bits[ ], which has a bit corresponding to
  * each of 32M possible hash values. pattern_bits[ ] is
  * “sparsely packed” to accelerate searching, (currently indicating
  about 8000 patterns with 32,000,000 bits. Thus we should get
  * about 1 hit in pattern_bits[ ]
  for every 4000 bytes of packet data scanned;
or
  * about one in every three full-size packets.
  * If a bit is set, that means the traditional hashing array
pat_table[ ] contains at
  * least one entry, which matches the hash value. pat_table is more
  * densely packed, containing only HASH_PATTERN_ENTRIES.
  *
  * pattern_bits[ ] contains HASH_PATTERN_BITS entries.
  * pat_table[ ] contains HASH_PATTERN_ENTRIES entries.
  *
  * INPUT:
  *  u_char * pktdata, - packet data to search
  *  int length,  - length of pktdata
  *  struct endpoint * ep - structure with “context” data for TCP stream
  *
  * The data block passed to this routine assumed to be sequential units
  * in a data stream. The “context data” is needed to catch patterns
  * which begin near the end of one block (aka packet), and continue
  * at the beginning of the next packet.
  *
  * RETURNS: pointer to pattern entry found
  in data, or (most often) NULL
  * if not found. If a pattern entry (pep) is returned, the byte pointed
  * to by the prefix pointer passed will NULL be set to the
  */
struct pattern_entry *
br_patscan(u_char * pktdata,
    int length,
    struct endpoint * ep)
{
  int i, sumx, savex; /* misc indices */
  u_long hashx;  /* hash index */
  u_long sum[SUMS];  /* sliding sums */
  u_long save[PATTERN_LENGTH]; /* saved 3-byte values */
  u_long acc;  /* accumulator */
  u_char * data;
  struct pattern_entry * pep;
  /* Use prefix data first, then switch to packet data */
  data = ep->pdata;
  /* seed the accumulators and sums from the prefix. If we run out of
    * prefix data we switch to new packet data until we've crunched
    * PATTERN_LENGTH bytes.
    */
acc = sumx = savex = 0;
for(i = 0; i < PATTERN_LENGTH; i++)
{
      /* see if it's time to switch to packet data */
      if(i == ep->pdlen) /* end of prefix data? */
    data = pktdata;
      acc = ((acc << 8) & 0x00FFFFFF) + *data++;
      /* initialize or update sum[ ] */
      if(i < SUMS)
    sum[sumx++] = acc;  /* initialize */
      else
    sum[sumx++] += acc;  /* accumulate */
    if(sumx >= SUMS)
    sumx = 0;
    save[savex++] = acc;
    if(savex >= PATTERN_LENGTH)
    savex = 0;
}
/* if we have not already done so, switch to packet data */
if(i == ep->pdlen)
    data = pktdata;
  /* The main pattern scanning loop */
  for(i = 0; i < (length − PATTERN_LENGTH); i++)
  {
    /* check for sum in huge hashed bitmask. Divide index
“sum[sumx]” by 8 so
      * first check to see if any bit in the indexed byte is set. If
      * so, then check to see if the indicated bit is set.
    hashx = (HASH_PATTERN_BITS − 1) & (sum[sumx] >> 3);
/* make bit array index */
    if(pattern_bits[hashx])  /* got a byte hit? */
    {
    /* see if there is 1 one in 32M-bit hit */
    if(pattern_bits[hashx] & (1 << (sum[sumx] & 0x07)))
    {
      /* Bit was set, so we should have an entry in the conventional hash
table
        * of pattern values. First, get the pointer to the hash bucket.
        */
      pep = pat_table[sum[sumx] & (HASH_{—}
      PATTERN_ENTRIES − 1)];
/* */
      /* look for a full match in hash bucket list. The while loop below
scans
        * the hash bucket's linked list, checking each entry for a full data
match
        * with the data passed to this routine.
        */
    while(pep)
    {
      int  cmplen;  /* length for compare */
      /* Set the compare length. Ideally this will be the length of the
        * pattern in the hash bucket, however if we don't have that many
bytes
        * left in the passed data buffer, then only compare what we have.
        */
      if((length − i) > pep->patlen)
      cmplen = pep->patlen;  /* compare whole hash bucket */
      else
      cmplen = length − i;  /* compare amount left in data */
      if(MEMCMP(pep->pattern,
      (data − (PATTERN_LENGTH + (SUMS−1))), cmplen) == 0)
      {
      /* data matched hash table pattern, as far as we can check */
      if(cmplen == (length − i))
      {
        /* We have a partial match, so return the length (in bytes)
          * for the pep->pattern portion which matched. This will be
          * returned as “prefix data” in the next call to this routine.
          */
        ep->pep = pep;
        ep->partial = cmplen;
      }
      else
      {
        /* We got a full pattern match, indicate this by clearing the
          * “partial” length
          */
        ep->partial = 0;
      }
      return pep;  /* return pointer to pattern info */
      }
      pep = pep->next;
    }
    }
  }
  /* Get here if the currently summed data block did not match any entry
an the
    * hash tables.
    */
  acc = ((acc << 8) & 0x00FFFFFF) + *data++;
  sum[sumx] −= save[savex];  /* subtract sum of data passing out of
window */
  sum[sumx] += acc;  /* add accumulator to new sum */
  save[savex] = acc;  /* save accumulator for later subtract */
  if(++savex >= PATTERN_LENGTH)  /* bump index if wrapped */
    savex = 0;
  if(++sumx >= SUMS)  /* bump index, handle wrapped */
  sumx = 0;
}
return NULL;
```

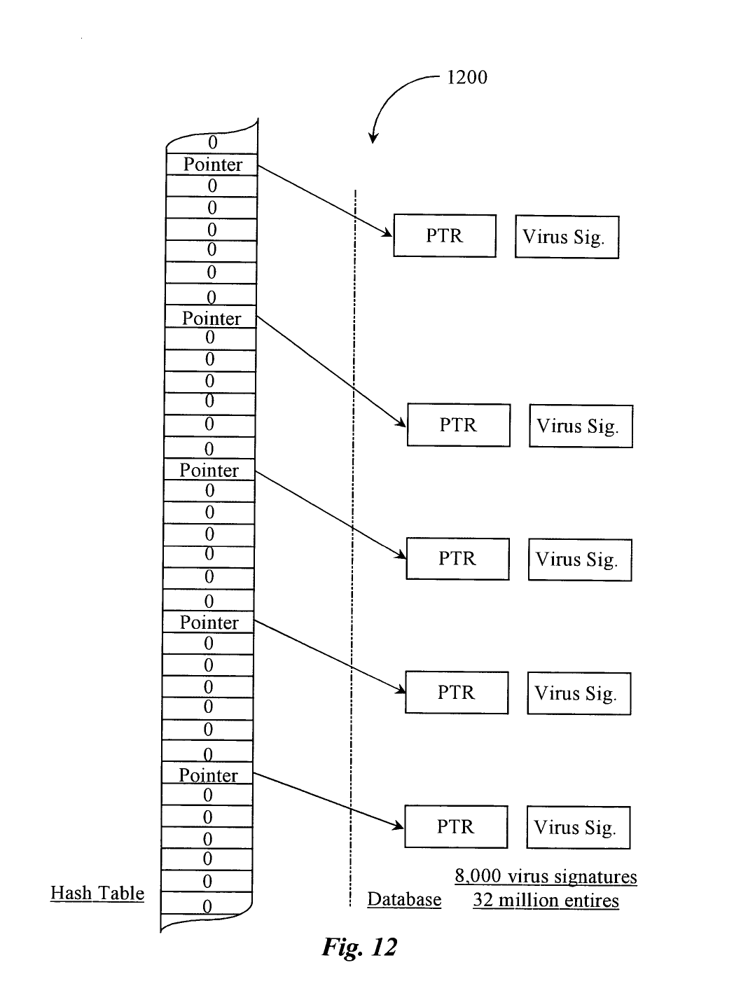

FIG. 12 is a block diagram 1200 illustrating a hash table and signature database according to the hashing embodiment of FIG. 11B. This example is logically illustrated as a hash table index used to reference a database of virus signatures. All known virus signatures (currently about 8000) are hashed by using a fixed length (9 consecutive bytes) of their binary images. The fixed length value can be thought of as the length of the key values used to point to each virus signature. The fixed length values are taken from each string in a way such that the values uniquely identify the signatures from whence they were extracted. For example a reference value or pointer may be taken from a virus string wherein the first byte of the string is included in the pointer, the remaining bytes consecutive. However the pointer or consecutive 9 bytes can be taken from any 9 bytes in a virus string as long as they are consecutive. It is important to note herein that it is not necessarily desirable to fashion a pointer from the last 9 bytes of a virus signature as detection thereof means that all bytes of that particular virus ahead of the key value was not detected in real-time hashing as described above. The criteria for creating the “keys” for each virus is that such keys produce random values and that they are unique to each virus. That is not to say that two or more viruses that have striking similar binary profiles cannot have the same key value.

The database is designed to contain 8000 signatures spread over 32,000,000 entries in a sparsely populated table. This means that a “hit” (created hash value matching a key value) has an approximate 1 in 4000 chance of occurring. Since no processing is required for a non-hit, the sparse table is much more CPU efficient.

Table Size Reduction Via Bit Masks

The sparsely populated array in this example above allows for a very fast lookup in the hash table, however the table itself is large. Assuming the size of the pointers in the hash index is 32 bits (4 bytes) the table becomes 128 Megabytes in size (32 Meg entries times 4 byte pointer size). This size exceeds the size that can be efficiently allocated by most computers without suffering some performance degradation. However, the entries in the sparse table are not limited to being 4-byte pointers. In a preferred embodiment the table is instead made up of 32Meg single bits, each of which is set whenever a hash table entry exists that corresponds to it's hash index, and clear if an entry does not exist. 32 Megabits fits in 4 Megabytes, which is much more practical than 128 Megabytes.

Actual pointers still need to be stored however they can be placed in a much more densely packed pointer array that is only referred to when the bit in the 32 Megabit table is set. This smaller pointer array can be indexed very efficiently by masking the 25-bit hash value used to access the bit table down to something smaller. In the example above, the mask used is 0×1FFF, which results in a table of 8191 entries, which is adequate for storing 8000 virus entries.

It will be apparent to one with skill in the art that the fast-pattern search method of hashing data and comparing the hashed values against an optimized has index is efficient enough that a standard Windows computer running a Pentium or similar chip-set can adequately handle virus detection in the background for a plurality of networked computers.

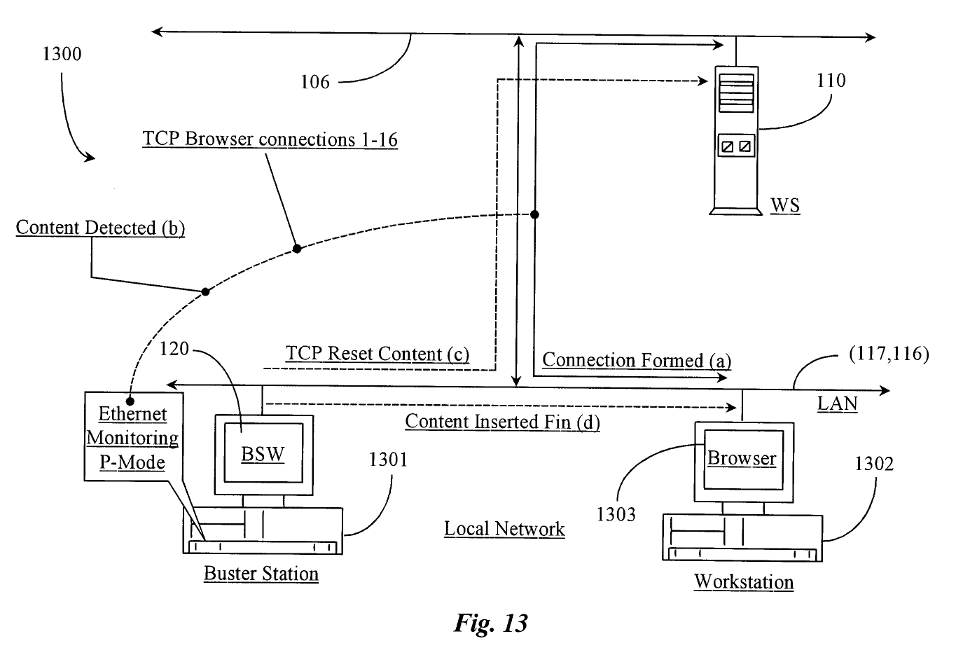

FIG. 13 is a network overview 1300 illustrating a process for replacing and/or filtering Web-content according to a preferred embodiment of the present invention. This process achieves the same goal as an alternate embodiment described further above with respect to FIG. 4 but requires much less resource dedication. This embodiment is preferred over the alternate embodiment because in this case the SW host does not act as a proxy server.

Overview 1300 includes Internet backbone 106 and WS 110 as was described with reference to the example of FIG. 4. Local network (116, 117) has a workstation 1302 running a Web browser 1303 for browsing electronic information offered by WS 110. A host workstation (Buster station) 1301 running SW instance 120, in this case allows a connection between station 1302 and WS 110 to form.

Station 1301, with the aid of P-mode monitoring, illustrated herein as a dialog box emanating from station 1301, monitors the browsing activity of station 1302. As long as no offensive content or questionable links are accessed, SW 120 may continue to enable full access and may not intercede. This monitoring process occurs with all of the active Web-connection data for all of the active browsing sessions detected on the network. Similarly, virus protection is on-going as was described further above.

Station 1302 forms a connection with WS 110 as is illustrated herein by a double arrow path labeled Formed Connection (c). Station 1301 using P-mode is monitoring the main TCP/IP connection for data. At this point in the session it is assumed that there are 16 open TCP connections (dynamically changing) open for data download as the Web session continues using browser 1303. SW 120 builds a database of these connections as the browsing session ensues.

Monitoring of content served over the 16 open connections is illustrated as a broken arc labeled TCP Browser Connections 1-16. There may be more or fewer TCP connections open and downloading data than are illustrated in this embodiment. This example is very similar to the example of FIG. 6 wherein TCP connections are monitored and reset to block pop-up advertisements. However, in this embodiment any WEB content can be filtered or replaced.

First the connection between station 1302 and WS 110 is allowed to form and to begin transmitting data. This is illustrated herein by a double arrow path labeled Connection Formed (a). Next using P-mode monitoring, data that is being transferred between the nodes of the connection is monitored. As data is scanned, it is compared first to any filtering criteria that may be active. For example, browser 1303 may invoke a link to a series of jpegs that may include questionable content according to a particular filter. In some cases, the jpeg content can be known before it is downloaded by comparing link data against any objectionable language or code that is part of the filter database. In some cases, the placeholders are analyzed before the jpeg data is downloaded to target over a particular TCP connection. In still other cases, unwanted data may be detected while a download is still in progress but not yet complete.

Detection of unwanted data is illustrated in this example by a label Content Detected (b). Any type of content can be compared against filter data using link data, title or label data, or parsed content word matching for downloaded text. The criteria for what may be acceptable and what may not be acceptable depends, of course on the environment, the user, and the level of security desired. For example, if the local network is a home network and the user is a child, any thing deemed inappropriate for children may be filtered or replaced with alternate content. If the network is a small office and the user is an employee, other criteria might be used.

It is noted herein that objectionable content can encompass a portion of or an entire HTML page of data. A decision can be made to kill a TCP/IP connection by resetting both ends of the connection or individual TCP connections responsible for download of a certain data portion without terminating the session. Assume that content detected is one or more objectionable jpeg files being downloaded into placeholders. Station 1301 sends a reset or resets to the TCP connection or connections responsible as illustrated herein by a broken single arrow path labeled TCP Reset Content (c).

After resetting the server side of the session to block certain content, one or more TCP packets can be sent to the remaining participant wherein the TCP packets have replacement WEB content in the payload portion for station 1302 that browser 1303 will display instead of the reset content. This action is illustrated herein by a broken arrow labeled content inserted TCP packets (d).

One example of replaced Web content would be a window containing a “message to the user” wherein the window takes the approximate size and spacing of the reset content. If the reset content is all of the particular Web page but the session is allowed to continue, the window with replacement content will take up the full screen area. It is noted herein that a single TCP packet may not be adequate to serve all of the replacement content. In this case there may be a sequence of TCP packets sent so that all of the Web content is displayed. Since station 1301 has reset server 110, station 1301 should also send a TCP FIN packet to 1302 when it's done inserting data. This action is illustrated herein by a broken arrow labeled send FIN packet (e). It is noted herein that a FIN packet can include a data payload. Therefore if the amount of data to be inserted is small enough for a FIN packet payload size then step (d) is optional.

Inserted content may include alternate Jpegs, audio messages, text content etc. In one embodiment the content is automatically formatted to replace the actual content that is reset. By knowing parameters of the reset connection such as placeholder description, the content can be formatted to fit into the placeholders of the original content. Station 1301 retrieves the content from a database (typically loaded into RAM) and rules govern which static content is inserted according to varied criteria. For example inserted content is associated with file data such that when a certain filter is activated triggering a connection reset, the replacement data if any is already known, is retrieved and inserted into one or more TCP packets for delivery to station 1302. Moreover, if it is determined that the nature of the HTML content being disseminated by browser 1303 is largely undesired, a TCP/IP reset may still be sent to both parties of the connection to kill the Web session.

In an alternate embodiment of the present invention, Web and other content may be statically held in an accessible server or repository accessible to the software of the present invention, but not loaded into RAM dedicated for Buster processing. A reason for not loading Web-content into RAM would be its graphically intense nature, which may use more RAM to process.

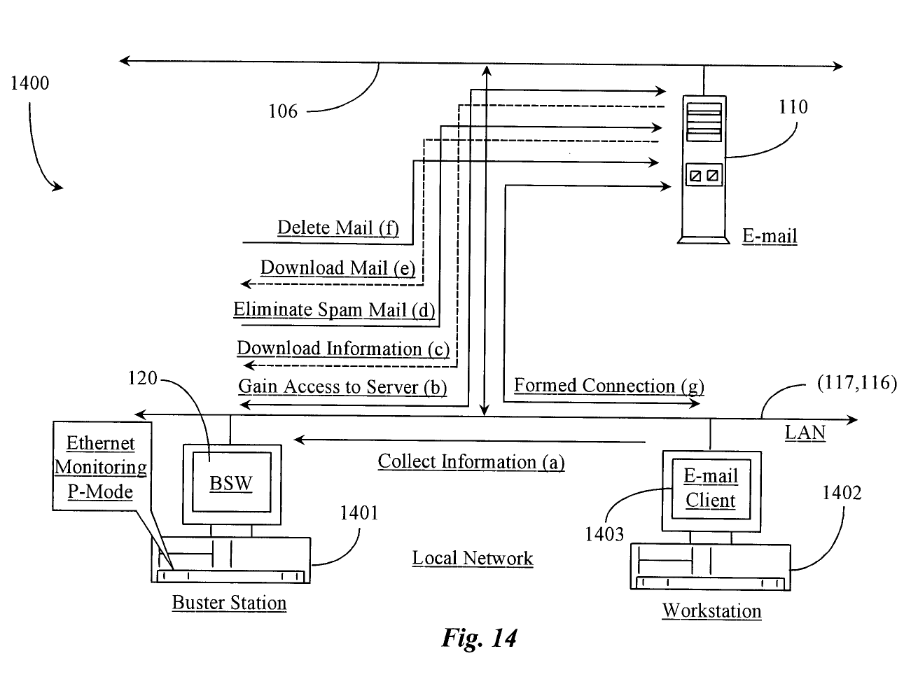

FIG. 14 is a network overview 1400 illustrating a process for scanning and filtering e-mail according to a preferred embodiment of the present invention. SW 120 has access to information about all stations on the local network (116, 117) and therefore all stations that have e-mail clients. Generally, users access their e-mail according to some form of a schedule even if a rather loose one. The goal of SW 120 in this example is to forge connections on behalf of the e-mail clients on the local network and filter and clean mail before clients make their own access to their e-mail server to get their mail.

Overview 1400 includes e-mail server 110 logically illustrated herein as the server used by clients on the local network such as a station 1402 running an e-mail client 1403. A station 1401 running SW 120 uses P-mode monitoring to collect client information from local workstations like station 1402 for example. This is illustrated herein by a single arrow path labeled Collect Information (a). The information collected includes the client e-mail address, the server path to server 110 in this example. The information is entered into a database repository loaded into RAM (not illustrated). Some information tuples such as e-mail log-on passwords can be entered manually by a system administrator or by a client served. Information also includes client address lists in the form of any white lists and/or black lists of sender e-mail addresses. Clients may also be allowed to set up their own level of Spam filter parameters. In some cases an authorized administrator retains control over setting the security levels for local clients as a group or on a case-by-case basis.

Step (a) of information collection is generally performed immediately after boot during set-up of the service for a local network. Step (a) may run indefinitely, even after all of the stations information has been collected including any manual information required. One piece of information that is initially collected and then refined for each client over time is e-mail access times for each client. That is to say that the service attempts to pin down the general schedules that are observed by clients when accessing and downloading their e-mails. Reasons for collecting and refining schedule information about each client will be explained further below.

Once all client information is collected, station 1401 running SW 120 can access server 110 posing as a client accessing e-mail from the server. This is illustrated in this embodiment as a double arrow path labeled Gain Access to Server (b). Access is gained on behalf of each client using the IP address of station 1401, but the client information of, in this example, the email user at station 1402. Particularly, access uses the server address and path to the servers e-mail interface for login. At login, station 1401 pulls the correct user name and password from the information collected in step (a) and inserts the information into the login transaction.

In a preferred embodiment, once access is granted station 1401 does not immediately download e-mails or attachments. Rather just information about the e-mails that are ready for download to client 1402 in this case. This action is illustrated in this example by a broken single arrow path labeled Download Information (c). The type of information accessed includes number of e-mails in the client inbox, the sender e-mail (return) information, the sender path information, subject lines, encryption status, etc. Station 1401 with the aid of SW 120 compares this information against client filter and preference data from the database. E-mails that meet the criteria for Spam or match any blacklisted data, are then deleted from server 110 without downloading them. This action is illustrated herein by a single arrow path labeled Eliminate Spam Mail (d). This action uses the e-mail protocol options for marking and deleting. A user normally performs these actions manually, however in this example, the actions are automated via program insertion or action “bot” that follows a pre-defined script.

After the e-mail for client 1402 has been filtered in the way just-described, station 1401 downloads the remaining e-mails form the client inbox and scans them further for Spam and for viruses using the fast-pattern technique described further above. This action is illustrated herein by a broken single arrow path labeled Download Mail (e).

Any further e-mails or attachments that can be identified as undesirable are eliminated from server 110. It is noted herein that in a preferred embodiment, the downloaded files are simply copies of the mails stored at server 110. Web-based mail services may leave a copy in the inbox even after downloading. The offending e-mails that have been determined to be undesirable are then deleted from server 110 by an action illustrated in this example as a single arrow path labeled Delete Mail (f). Now the only e-mails left in the client inbox for station 1402 are e-mails that are deemed appropriate.

It is noted herein that steps (a) through (f) occur before and as close to the scheduled time when client 1402 will normally access server 110 to download e-mail. The entire access and filtering process can be thought of as occurring during a window of opportunity immediately before and not overlapping with any access action performed by client 1402. In this regard, it is the goal to leave the span of time between log-off by the system and log-on by the client as small as possible so that no e-mails arrive before the client begins its normal routine of downloading of mail. It is noted herein that it is possible that an e-mail will arrive during the period in-between log-off by station 1401 and log-on by station 1402. However, SW 120 is continually checking for virus signatures and therefore still offers some measure of protection. One or a few Spam mails may slip through but the result is far more desirable than many Spam e-mails downloaded.

This example does not apply to e-mail systems that offload e-mails at the time of access that is, automatically downloading and emptying of the client's mail into the client's inbox. A store and forward method can be used for these types of download situations.

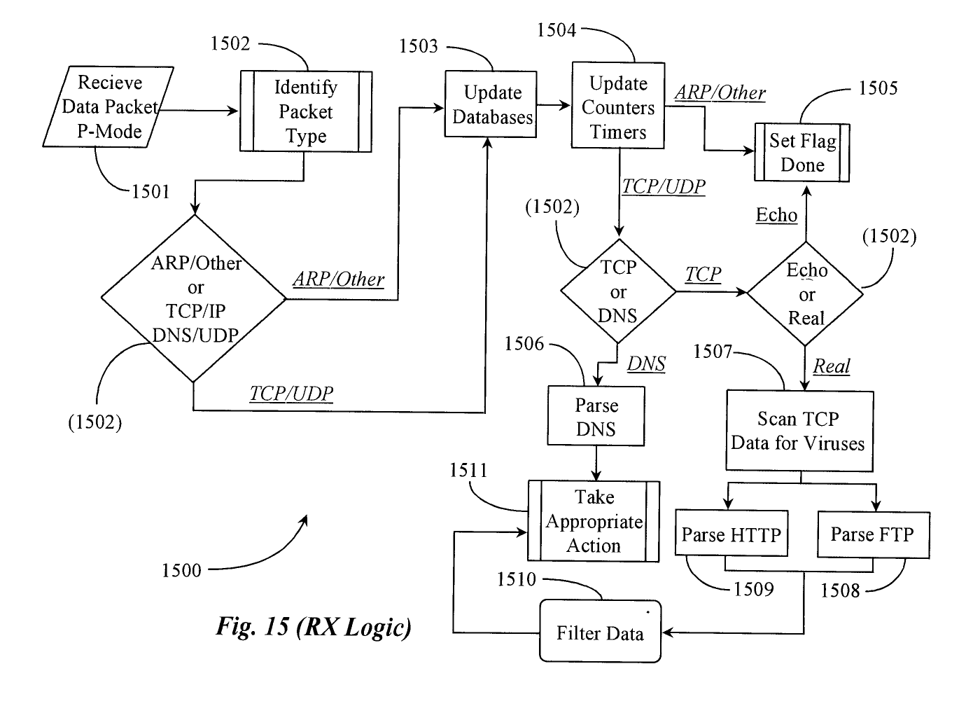

FIG. 15 is a process flow chart 1500 illustrating basic receiving logic for data packets. At step 1501 a data packet is received using Ethernet P-mode or a similar technology. At step 1502 SW 120 identifies the type of packet received whether IP, ARP, ICNP, TCP, UDP, or some other packet type. Packets that are below the IP layer such as hardware control messages, error messages and so one or not retained for processing. Step 1502 determines what type of later processing will be required dependant on packet type received and retained for processing. It is noted herein that step 1502 is a complex process wherein packet header fields are analyzed for values and therefore requires many sub-steps to perform. In this example, the different packet definitions are retained for identification in further packet processing, which may vary depending on the packet type as identified in step 1502. Therefore diamond shape or “decision” blocks illustrated later in this process flow refer by element number back to step 1502 to indicate that identification was made in step 1502.

If the packet received at step 1501 is an ARP packet or other type of IP packet or it is a TCP or UDP, then at step 1503 the appropriate databases are updated with pertinent information taken from the packet. This step updates information for IP host and MAC host databases as well as the connections database. It is noted herein that certain packet types such as TCP/UDP may receive priority in treatment at step 1503 if there are many packets queued for processing. At step 1504 counters and timers are also updated as well as activity time stamping performed to keep track of bytes and packets received per second. Steps 1503 and 1504 are performed for all packets.

At step 1505, ARP and Other packet types that are not TCP or UDP packets are flagged as done. That is to say that processing is complete for these packets. Any type of flagging schema can be used such as setting a bit to 1 or 0 in a packet header field provided and adapted for the purpose. TCP and UDP packets identified in step 1502 are treated differently from each other depending on the identification granularity. For example, if the packet is a DNS/UDP packet, in step 1506 it is handed off to a DNS parser analogous to module 214 described with reference to FIG. 2B above.

After parsing the DNS packet, the appropriate action is taken at step 1511. This step may include generating and sending a DNS reply to a DNS request for a pre-defined domain name known to SW 120 via database entry. In some cases no action is taken because it is a standard DNS/UDP request. Therefore step 1511 represents the end of processing for DNS packets.

If the identified packet is a TCP packet, which is the type packet of most concern, and it is an echo packet (a packet previously sent by Buster, and “echoed” back by the network MAC driver or hardware), then at step 1505 a flag is set to done meaning “done processing”. However if the identified packet is TCP and real then at step 1507 the TCP packet is scanned for viruses using the fast pattern search method of the present invention. It is important to note herein that full identification of each received packet is determined at step 1502 before processing. Therefore if the packet is a TCP echo packet, the steps for updating databases and setting counters or timers are not required as a flag would have already been set telling the system at step 1502 that the packet was a TCP/IP echo from the TCP/IP stack. In the case of TCP echo, steps 1503 and 1504 are bypassed.

Step 1507 is performed in the background continuously for all active TCP packets detected on the network. If there is a virus match detected at step 1507, then the process resolves to step 1511 whereupon appropriate action is taken such as sending a reset to the virus source node to kill the connection preventing complete download thus thwarting a possible end-node infection. Moreover a further step for user notification of the action taken may be included under step 1511. An alert may also include a command for an operator or a machine-to-machine self-executing command. An e-mail or messaging client analogous to module 212 can be called to send an alert or notification.

A TCP packet is further identified in step 1502 as an HTTP type or an FTP type TCP packet. Therefore, if the packet is TCP and real the appropriate parsing step is performed. For example, if TCP HTTP then it is handed off to an HTTP parser at step 1509 for parsing. At step 1510 the TCP data is filtered according to parsed results and database look-up. After filtering the TCP HTTP packet the appropriate resulting action is taken at step 1511. Step 1511 may also include a sub-step for sending one or a combination of reset/FIN packets including a sequence of TCP packets holding Web content for insertion. In still another embodiment step 1511 may include alerting one of the connection node by e-mail or message program.

If the TCP packet is FTP and real it is handed off to an FTP parser at step 1508 and then filtered at step 1510 similarly as an HTTP packet. Again at step 1511 an appropriate action is taken according to filter results. It is noted herein that an appropriate action may be interpreted also as taking no action.

It will be apparent to one with skill in the art that the described steps and order thereof in process flow 1500 can vary without departing from the spirit and scope of the present invention. The actual RX logic described basically in this example is far more complex than the basic steps reveal. For example, packet identification (1502) requires many sub steps related to scanning packet header fields and the like. The inventor only illustrates the basic steps of most concern such as scanning TCP/IP packets for viruses, Analyzing DNS requests for intervention, and filtering data from formed connections wherein actions (1511) may include content insertion via sending a combination of RST and FIN packets.

The method and apparatus of the present invention effectively controls a variety of network security issues using TCP/IP packet insertion, which can be performed for the purpose of denying a connect attempt, killing a formed connection, blocking certain HTML content, directing a local client to a shared resource, and the like. The method and apparatus of the present invention can also detect viruses before they can do any harm to local network systems using the unique fast-pattern search method described further above.

Denying SYN Flood Attacks

The SW of he present invention may also be used to protect local resources against a typical DOS SYN flood attack.

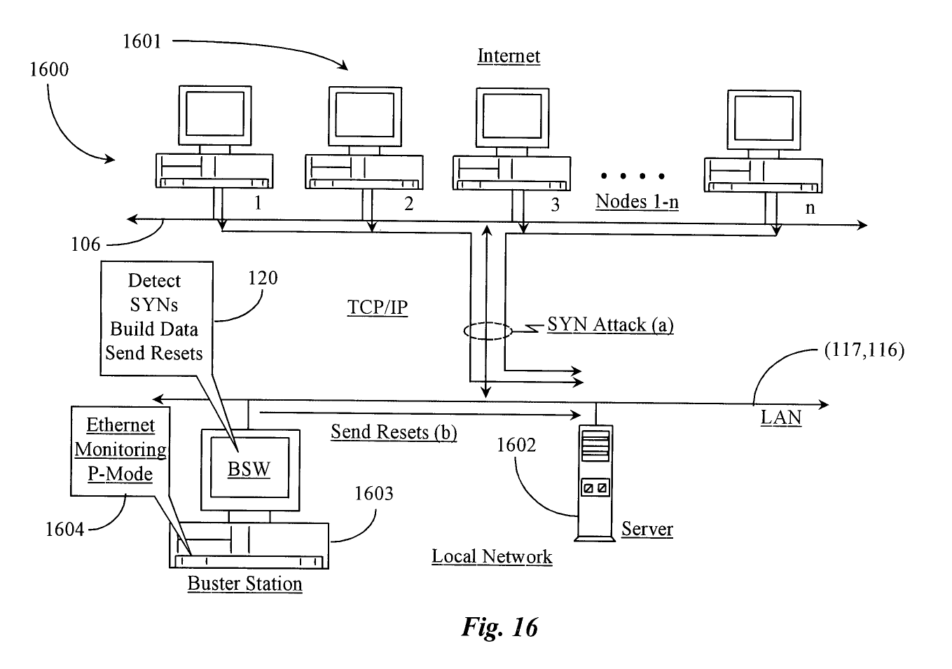

FIG. 16 is a network overview 1600 illustrating protection against a denial of service (DOS) SYN attack according to an embodiment of the present invention. Overview 1600 encompasses the Internet network illustrated herein by backbone 106 and a local LAN network illustrated herein by LAN (116, 117). In this example a plurality of nodes 1601, also illustrated herein as nodes 1-n are shown connected to backbone 106. On the local side (LAN 116, 117) a sever 1602 is illustrated and is connected for service. Server 1602 may be a Web server adapted to provide outside contact services or other customer services for an enterprise presumed to maintain LAN (116, 117).

A Buster station 1603 running an instance of SW 120 is provided to protect network (116, 117). Station 1603 is operating in a P-Mode 1604 as described in numerous references above. In this example, stations 1-n are engaged in a DOS SYN attack sometimes termed a SYN Flood attack in the art. The target is server 1602 as is illustrated herein by attack paths enclosed by a broken ellipse labeled SYN attack. It only requires one station to launch a SYN attack on a server. In this embodiment a plurality of stations are involved in a coordinated attack.

In a SYN attack many SYN packets are sent to request synchronization with the target server. The SYN packets usually come from a non-existent or impersonated IP address. Therefore the server's attempts to acknowledge the SYN packets have no effect. The goal of the attack is to disable the server by causing it to dedicate all of its resources processing the SYN packets.

Station 1603 with the aid of SW 120 operating in P-mode can detect an attack by noticing an unusual amount of, in this case SYN packets addressed to the same server 1602. SW 120 then builds a special connections database to identify the TCP ports involved in receipt of the SYN packets identified as part of the attack. The hacker launching a SYN attack normally uses a phony, non-existent IP address in the attack. This phony address makes it impossible for Buster to reset the source of the attack. Part of the success of a SYN attack is that the server, in this case server 1602 cannot complete the TCP/IP connection or connections with the source node or nodes of the attack.

In this example, there are multiple nodes 1-n attacking. The SYN packets may contain only one phony IP address or more (one for each node to use). It may also be possible that every SYN packet has a different source address. SW 120 operating in P-mode counts SYN packets, which are never followed up with an ACK from the remote machine. An excessive count of such connections indicates a DOS SYN flood attack. As these connections are identified, SW 120 generates TCP/IP resets to the local server (1602) after each detected SYN packet received for a particular TCP connection. The server then drops ACK response processing for those SYN attempting to affect a port. In essence, SW 120 denies effectiveness of the attack during the lifetime of the attack by interceding in the server's process for response, eliminating the need to respond. The local proximity of Buster station 1603 to server 1602 makes this possible. As all of the TCP connection attempts are identified and treated, the attack has little effect and server 1602 can continue dedicating resources to legitimate connections.

It may also be possible to free the server's resources with packets other than a TCP reset, such as TCP FIN or certain ICMP packets. Using these and other packets to clear the effects of a SYN flood attack are within the spirit of the current invention. This invention should also prove useful for reducing the effects of other denial of service attacks, such as SYN/ACK floods.

TCP Throttling

The software of the present invention can also be used as a fourth-party throttle control for TCP connections that are “hogging” too much network bandwidth for lower priority communication.

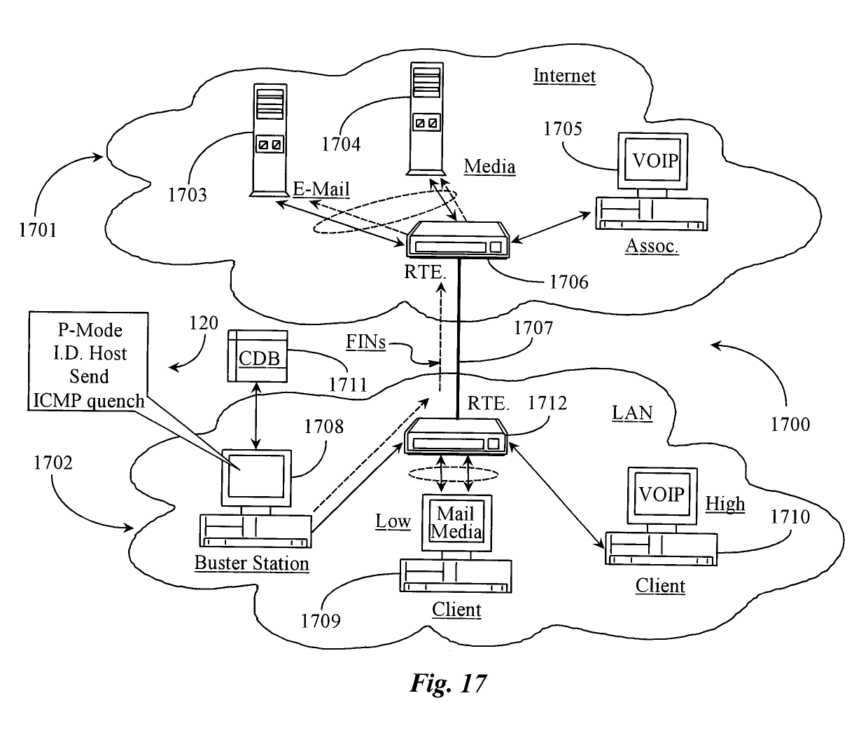

FIG. 17 is a network overview 1700 of a method for slowing down a data send rate to conserve local network bandwidth according to an embodiment of the present invention. Overview 1700 includes an Internet network 1701 and a local network or LAN 1702. Internet network 1701 contains an E-mail server 1703 and a media server 1704. Server 1703 is analogous to e-mail server 110 described with reference to FIG. 14 above in both function and description. Media server 1704 is adapted to sever multimedia content such as, perhaps video content, audio content, and other bandwidth demanding content.

A workstation 1705 is illustrated in Internet 1701 and is meant to represent a business associate (Assoc.) operating from a remote location and making connection to LAN 1702 using the Internet as a conduit. The operator of station 1705 has legitimate and high priority business to conduct with a counterpart based on LAN 1702. A router or gateway 1706 (RTE.) is illustrated within Internet 1701 and represents a last routing-point node between Internet 1701 and LAN 1702. Nodes 1703, 1704, and 1705 have their data that is destined to one or more addresses on LAN 1702 forwarded through router 1706.

A plurality of workstations is illustrated on LAN 1702. These are a Buster station 1708, a client station 1709, and a client station 1710. A router 1712 (RTE.) is illustrated on LAN 1702 and is adapted as a first routing point for data sourced externally and as a last routing point for internal data destined for external destination. Router 1712 is analogous in this example to router 909 described with reference to FIG. 9 above. Routers 1706 and 1712 have communication between each other via a T1, DSL, ISDN (1707), or other network line as previously described with reference to FIG. 1 of this specification.

In this example, station 1709 has open and active TCP connections with both server 1703 (e-mail) and server 1704 (media). This activity is illustrated herein by double-arrow paths between node 1709 and router 1712 (enclosed in broken ellipse), and between router 1706 and each of the aforementioned servers 1703 and 1704 (enclosed in broken ellipse). Therefore, an operator is using a single workstation (1709) To download e-mail from server 1703 and bandwidth intensive media from server 1704 simultaneously.

During the same period as the activity mentioned above, station 1705, running a VOIP application is communicating with station 1710 also running VOIP. The VOIP communication is considered a higher priority than the e-mail and media download, which are considered low priority from the perspective of LAN 1702. This designation is represented herein by labels “Low” associated with station 1709 and “High” associated with station 1710.

With respect to Quality of Service (QoS) implements and services that may be in effect over a TCP/IP connection, these may not be adequate enough to guarantee acceptable service to the higher priority connection while still providing quality to the lower priority connection on a same local network.

In practice, SW 120 leverages a well-known protocol ICMP that is typically practiced between routers to manage buffer memory. ICMP is an Internet protocol described by RFC specification 792 published in 1981. In typical practice ICMP “source quench” packets are originated by a router and sent to an end node (client or server) to tell the end node to slow down the rate of data currently being sent. Support for the source quench packet is usually implemented internally on TCP stacks by causing an internal variable called the “congestion window” to be set to a low value, which will slow the rate of data on the connection. As the TCP connection successfully transfers data over time, the TCP stack sending the data will increase the congestion window. Subsequent ICMP source quench packets may be used to force the congestion window back to a low value, thus keeping the connection running at a slow pace indefinitely. It is reminded herein that the mechanism currently known is for managing buffer memory for a store and forward device.

A typical TCP/IP stack running on a desktop computer allows for 16 K bytes of data to be sent from a remote router during a download. This limit in Ethernet terms is a window of about 10 data packets. If station 1709, for example is downloading from server 1704 as is the case in this embodiment, router 1706 will load 16 K-bytes for send over line 1707. Of course, if line 1707 is idle this will use 100% of the available bandwidth over this potential bottleneck. Station 1710 attempting to conduct a VOIP session will have to wait while VOIP packets wait behind 16 K-bytes of data sourced from server 1704 waiting at router 1706 for send. The result is a serious degradation, if not outright failure of the VOIP communication.

The inventor is aware of a prior-art method referenced herein as U.S. Pat. No. 6,038,216 that attempts to control the rate at which data is sent in a packet environment by inserting a latency into a TCP ACK packet stream and altering TCP headers. The method uses a mechanism to manipulate selected packet header fields and requires enhancement to host-system or router TCP/IP software in order to practice the invention. SW 120 does not require any additional mechanisms or enhancements to TCP/IP software in order to leverage the existing protocol of ICMP. The only requirement is that the offending connections can be identified. Ethernet P-mode has the capability of detecting offending connections by counting packets and determining the size of those packets. The connections database holds all of the required mapping parameters for each open TCP connection doing business on the local network.

In practice of the present invention, SW 120 throttles back TCP connections sending bulk data of low priority by sending ICMP packets to the remote TCP node that is sending the packets. The technique has nothing to do with buffering; rather it is used to allocate more bandwidth to active connections of a higher priority. The method can be practiced without sending resets or FIN packets, or altering TCP header acknowledgment and “window” values as outlined in U.S. Pat. No. 6,038,216.

In this example station 1709 is accepting bulk data from both servers 1703 and 1704 effectively limiting bandwidth available over line 1706 to facilitate a decent VOIP session underway between station 1710 and station 1705. In this case SW 120 leveraging Ethernet P-mode sees that packets associated with station 1709 and notes the frequency and average size of the packets. The priority of the instant streams can be discerned by parsing sample packets for header information and even payload sampling. It is assumed that a priority scheme exists and is stored, perhaps along with connections data, which identifies a priority rating for the type of data being downloaded. A combination of connections information and content can be analyzed to set a priority ranking for the stream.

SW 120 recognizes through connections information that the VOIP stream is of a higher priority than the e-mail and media streams. SW 120 then generates one or more ICMP source quench packets and sends the ICMP packets to nodes 1703 and 1704. Nodes 1703 and 1704 then adjust their congestion windows for transferring data to a lower value on each connection. The throttle effect depends partly of the frequency of ICMP source quench requests. In one embodiment only one of the offending TCP connections requires attention. For example, by throttling back the rate of media data sent, enough bandwidth could become available for the VOIP session to be conducted at an acceptable quality level.

Because multimedia streams are heavy anyway (require significant buffering) throttling back the offending connection does not perceptibly affect the quality or speed of the downloaded stream from the viewpoint of the user operating station 1709. The fact is that in most cases more bandwidth is utilized than is necessary. The rate of ICMP send can also be adjusted on the fly by continuing to monitor packets in P-mode for frequency of receipt and size.

The method described above assumes administrative control, however the method may be automated by applying a weighted average value to all active TCP connections so that when the value (representing a limit) is approached ICMP intervention may be launched.

The methods and apparatus of the present invention can be provided in both hardware/software embodiments and in software only embodiments without departing from the sprit and scope of the present invention. In one embodiment of the present invention a low scale version of Buster can be provided as a single software solution for single computer users wherein no second machine exists on a network. Such an application might be suitable for a laptop computer that is used on an Ethernet network occasionally but also as a main desktop business or personal computer while not networked.

The present invention should be afforded the broadest possible consideration under examination in lieu of the many possible and varied use embodiments many of which have already been described. The spirit and scope of the present invention shall be limited only by the following claims.

1. A system for providing network security by managing and manipulating formed data connections and connection attempts initiated over a data-packet-network between at least two nodes connected to the network comprising:
a system host machine connected to the network;
a first software application residing on the host machine for detecting and monitoring the connections and connection attempts;
a data store for storing data about the connections and connection attempts; and
a second software application for emulating one or more end nodes of the connections or connection attempts;
characterized in that the system using the detection software detects one or more pre-defined states associated with a particular formed connection or connection attempt in progress including those associated with any data content or type transferred there over and performs at least one packet generation and insertion action triggered by the detected state or states, the packet or packets emulating one or more end nodes of the connection or connection attempt to cause preemption or resolution of the detected state or states.

2. The system of claim 1 wherein the data-packet-network encompasses a Local Area Network connected to the Internet network enhanced with Transfer Control Protocol over Internet Protocol and User Datagram Protocol over Internet Protocol.

3. The system of claim 1 wherein the system host machine is one of a desktop computer, a router, an embedded system, a laptop computer, or a server.

4. The system of claim 1 wherein the system host is an especially dedicated piece of hardware.

5. The system of claim 1 wherein emulation of the end nodes of the connections or connection attempts is performed by generation and insertion into a data stream of the connection or connection attempt data packets using Transfer Control Protocol over Internet Protocol, the packets emulating packets from the current sending node in the connection.

6. The system of claim 5 wherein the packets inserted into a connection or connection attempt are one or a combination of Transfer Control Protocol reset packets or Transfer Control Protocol FIN packets.

7. The system of claim 1 wherein the nodes participating in the connections or connection attempts are desktop computers, servers, embedded systems, laptop computers or a combination thereof.

8. The system of claim 1 wherein the data-packet-network is an Ethernet network connected to the Internet network and the first software application is an Ethernet driver set to operate in promiscuous mode.

9. The system of claim 1 wherein the data about the connections or connection attempts includes one, more, or a combination of sender and receiver Internet Protocol addresses; Universal Resource Locators; source and destination ports; Transfer Control Protocol packet sequence numbers; Ethernet machine addresses; domain names; and packet header details.

10. The system of claim 1 wherein the data store comprises segregated datasets representing one or more of banned Internet Protocol addresses; banned domain names; banned Universal Resource Locators; banned network ports; and virus signatures.

11. The system of claim 1 wherein the data store further includes Ethernet machine addresses associated with bitmap icons representing individual machine types.

12. The system of claim 10 wherein certain ones of the segregated datasets are built during runtime, maintained temporarily, and searchable by one of hash table indices or binary tree indices.

13. The system of claim 10 wherein certain ones of the segregated datasets are uploaded into host Random Access Memory upon booting of the host system.

14. The system of claim 1 further including a third software application for detecting virus activity comprising:
a software routine for hashing data passed over a formed data connection; and
a software routine for comparing the hash data to a dataset containing virus signatures, the dataset searchable by hash table index, the hash entries therein derived individually from separate virus signatures.

15. The system of claim 14 wherein the hashing routine utilizes at least one sliding checksum window processing data and in the case of more than one, operating simultaneously on the data creating hash values to compare against hash entries in the hash index.

16. The system of claim 15 wherein upon detecting a hit for a virus signature, the second software application interrupts data stream processing of one or more end points of the connection by sending a reset packet to stop download of the detected virus.

17. A software application for manipulating one or more connection ends of a data network connection between two or more network nodes operating on a data-packet-network in response to detection of a pre-defined and undesirable state or states associated with the connection comprising:
a first portion thereof for detecting one or more states associated with the connection;
a second portion thereof for generating packets emulating packet activity of the connection; and
a third portion thereof for sending the emulated packet or packets to one or more parties of the connection;
characterized in that the application uses a software communication stack to send one or more Transfer Control Protocol packets emulating in construction and sequence number a packet or packets sent by a sender end of the connection, the packet received by the receiver of the connection wherein the receiving end acknowledges the packet or packets as being a valid packet or packets received from the sender of the connection, the packet or packets sent causing pre-emption or resolution of the detected state or states.

18. The software application of claim 17 wherein the data-packet-network comprises a local-area-network enhanced with Transfer Control Protocol over Internet Protocol and User-Datagram Protocol over Internet Protocol.

19. The software application of claim 18 wherein the Local Area Network is an Ethernet network connected to an Internet network.

20. The software application of claim 17 wherein manipulation of connection ends is performed by generation of and insertion of data packets to one or more nodes of the connection using Transfer Control Protocol over Internet Protocol, the generated packets emulating sender packets in construction and sequence number.

21. The software application of claim 17 wherein the packets inserted into a connection data stream are one or a combination of Transfer Control Protocol reset packets or Transfer Control Protocol FIN packets emulating at least one sending party of the connection.

22. The software application of claim 17 wherein the software communication stack is an on-board Transfer Control Protocol over Internet Protocol communication stack.

23. The software application of claim 17 wherein a pre-defined state includes one, more, or a combination of a banned Internet Protocol address; a banned Universal Resource Locator; a banned domain name; a detected virus signature; a banned port; and banned data content defined by filter.

24. The software application of claim 17 wherein the connection end nodes are desktop computers, servers, embedded systems, laptop computers, or a combination thereof

25. The software application of claim 17 wherein Transfer Control Protocol packets are generated and inserted according to pre-defined trigger events associated with existing states or knowledge of imminence thereof discovered during operation.

26. The software application of claim 17 further including a portion thereof integrated with the first portion for detecting virus activity comprising:
a routine for hashing data passed over a formed data connection; and
a routine for comparing the hash data to a dataset containing virus signatures, the dataset searchable by hash table index, the hash entries derived individually from the virus signatures.

27. The system of claim 23 wherein the predefined state is banned content and resolution thereof includes inserting content including machine readable script by one or a sequence of TCP packets containing replacement content.

28. The software application of claim 26 wherein virus searching is supported by algorithm supporting generation and then comparison of created hash values derived from active connection data streams to hash table entries stored in a data store and to return a hit upon obtaining a match.

29. The software application of claim 26 wherein the third portion thereof is integrated with a messaging client for generating automated alerts to end nodes whose connections have been manipulated.

30. The software application of claim 26 including one or more sliding checksum windows for hashing data transferred over an active connection.

31. The software application of claim 30 wherein each checksum window processes 9 bytes of data 3-bytes at a time, each three-byte section treated as a single 24-bit number.

32. The software application of claim 26 wherein the hash table is sparsely populated and wherein the index thereof is bit-masked to reduce the overall size of the table and increase performance of the search.

33. A fast pattern search system for detecting virus patterns over a data network comprising:
a promiscuous mode driver for intercepting data packets on the network;
a hashing module for creating hash values from same-lengths of intercepted data;
a data buffer section for storing hash values; and
a processing component for comparing created hash values to an index of hash entries maintained in a data store;
characterized in that the hash entries in the data store point to virus patterns also stored in the data store and where upon a match between a created hash and a hash entry results in generation of one or more packets emulating at least one party node to the connection, the packet or packets sent to pre-empt the download of the particular virus found.

34. The system of claim 33 wherein the network is a local area network enhanced with Transfer Control Protocol over Internet Protocol and User Datagram Protocol over Internet Protocol, the Local Area Network connected to the Internet network.

35. The system of claim 34 wherein the promiscuous mode driver is an Ethernet driver and the network protected is an Ethernet network or a segment thereof.

36. The system of claim 33 wherein the length of data hashed to form a single hash value from a connection data stream is 9-bytes.

37. The system of claim 33 wherein the hashing module employs one or more sliding checksum windows and re-calculates new hash values based on data units entering or exiting the window.

38. The system of claim 37 wherein the 3-byte sections are treated as a single 24-bit number.

39. The system of claim 33 wherein the data buffer is RAM buffer.

40. The system of claim 33 wherein more than one packet is generated and sent upon a match, the packets comprising a TCP reset packet sent to the source node of the virus and a TCP FIN packet sent to the receiving node of the virus.

41. The system of claim 33 wherein more than one packet is generated and sent upon a match, the packets comprising a TCP reset packet sent to the source node of the virus and a TCP reset packet sent to the receiving node of the virus.

42. The system of claim 33 further comprising a routine for calling a messaging client to generate a message alert and then sending the alert to the receiving node of the virus, the alert informing of the activity and providing further instruction.

43. The system of claim 33 further comprising a routine for calling a machine-to-machine messaging protocol to send a machine readable command to an application running on the receiving node of the virus, the application adapted to clean history files and any logical or physical links or references to the virus source.

44. A method for denying a connection to a data source on a data network, the connection initiated from a local network node comprising steps of:
(a) maintaining data identifying the banned data source;
(b) detecting a SYN packet from the local node sent to the host node of the banned data source, the SYN packet identifying at least the banned data source;
(c) generating a TCP reset packet emulating one sent from the local node and sending the packet to the host node of the banned data source terminating the handshake process for accessing the data source at the host node of the banned data source; and
(d) generating a TCP reset packet emulating one sent from the host node of the banned data source and sending the packet to the local node terminating the handshake process for accessing the banned data source at the local node.

45. The method of claim 44 wherein in step (a) the banned data source is identified by one or a combination of IP address, Universal Resource Locator, port identification or any portion thereof.

46. The method of claim 44 wherein in step (b) the local node is connected to an Ethernet network and the host node is maintained on the Internet network, the method of detection comprising promiscuous mode monitoring and comparison against stored data.

47. A method for stopping a download of a pop-up advertisement over a data network from a data source to a local node on the network comprising steps of:
(a) monitoring a browser session between the local node and the source node;
(b) detecting execution by the local browser of an embedded code calling an advertisement to be served;
(c) generating a TCP FIN packet emulating one sent from the data source node and sending the packet to the local node, the packet indicative that the source node has finished transmitting the ad data; and
(d) generating a TCP reset packet emulating one sent from the local node to the TCP connection source of the ad data requesting a reset of the connection preventing the source node from serving the ad data.

48. The method of claim 47 wherein the local node is connected to an Ethernet network and the data source is maintained by a node on the Internet network, the method of detection comprising promiscuous mode monitoring and comparison against stored data.

49. The method of claim 47 wherein in step (c) the FIN packet includes a machine-readable code containing one or more instruction codes for the browser application.

50. The method of claim 49 wherein in step (c) the machine-readable code is JavaScript instructing the browser not to open a container window for the ad data and to close the container window if already called.

51. A method for configuring a resource on a local network for access from the network by a node using Domain Name Service protocol comprising steps of:
(a) pre-assigning a name to the shared resource;
(b) storing the pre-assigned name in a data store;
(c) publishing the pre-assigned name to local nodes on the network;
(d) monitoring Domain Name Service requests from the local nodes;
(e) detecting the pre-assigned name in a request;
(f) generating a Domain Name Service reply emulating in construction and sequence number a reply sent from a Domain Name Server, the reply containing an IP address through which the resource may be accessed; and
(g) sending the reply to the local node that initiated the request.

52. The method of claim 51 wherein in step (a) the shared resource is one of a printer, a server node, or a network-based software application.

53. The method of claim 51 wherein in step (a) the pre-assigned name is not registered at a Domain Name Server.

54. The method of claim 51 wherein in step (d) monitoring the network for Domain Name Service requests is performed in promiscuous mode using an Ethernet driver wherein the local network is an Ethernet network.

55. The method of claim 51 wherein in step (e) detection is accomplished by comparing all requests for Domain Name Services made from local nodes to the store containing the pre-assigned Domain Name.
